(19) United States
(12) Patent Application Publication
(10) Pub. No.: US 2025/0351034 A1
(43) Pub. Date: Nov. 13, 2025

(54) METHOD AND APPARATUS FOR MEASURING SERVING CELL OF TERMINAL SUPPORTING LOW-POWER WAKE-UP RECEIVER IN WIRELESS COMMUNICATION SYSTEM

(71) Applicant: Samsung Electronics Co., Ltd., Suwon-si (KR)

(72) Inventors: Sangyeob JUNG, Suwon-si (KR); Byounghoon JUNG, Suwon-si (KR)

(21) Appl. No.: 19/202,687

(22) Filed: May 8, 2025

(30) Foreign Application Priority Data
May 9, 2024 (KR) 10-2024-0061126

(51) Int. Cl. H04W 36/00; H04W 52/02

(52) U.S. Cl. CPC H04W 36/0088; H04W 52/0235

(57) ABSTRACT

The disclosure relates to a fifth generation (5G) or sixth generation (6G) communication system for supporting a higher data transmission rate. A method and an apparatus for measuring a serving cell of a user equipment (UE) supporting a low-power wake-up receiver in a next-generation mobile communication system are provided. The method includes receiving, from a base station, configuration information on a cell reselection, preforming a measurement based on the configuration information using a main radio (MR) of the terminal, and in case that a result of the measurement is higher than a predetermined threshold, determining to relax the measurement using the MR of the terminal.

### CROSS-REFERENCE TO RELATED APPLICATION(S)

This application is based on and claims priority under 35 U.S.C. § 119(a) of a Korean patent application number 10-2024-0061126, filed on May 9, 2024, in the Korean Intellectual Property Office, the disclosure of which is incorporated by reference herein in its entirety.

### BACKGROUND

### 1. Field

The disclosure relates to operations of a user equipment (UE) and a base station in a mobile communication system. More particularly, the disclosure relates to a method and an apparatus for measuring a serving cell of a UE supporting a low-power wake-up receiver in a next-generation mobile communication system.

### 2. Description of Related Art

Fifth generation (5G) mobile communication technologies define broad frequency bands such that high transmission rates and new services are possible, and can be implemented not only in “Sub 6 GHz” bands, such as 3.5 GHz, but also in “Above 6 GHz” bands referred to as millimeter-wave (mmWave) including 28 GHz and 39 GHz. In addition, it has been considered to implement sixth generation (6G) mobile communication technologies (referred to as Beyond 5G systems) in terahertz bands (for example, 95 GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced mobile broadband (eMBB), ultra reliable low latency communications (URLLC), and massive machine-type communications (mMTC), there has been ongoing standardization regarding beamforming and massive multiple-input multiple-output (MIMO) for mitigating radio-wave path loss and increasing radio-wave transmission distances in mmWave, supporting numerologies (for example, operating multiple subcarrier spacings) for efficiently utilizing mm Wave resources and dynamic operation of slot formats, initial access technologies for supporting multi-beam transmission and broadbands, definition and operation of bandwidth part (BWP), new channel coding methods, such as a low density parity check (LDPC) code for large amount of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies, such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, NR UE power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies, such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies, such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and artificial intelligence (AI) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and an apparatus for measuring a serving cell of a UE supporting a low-power wake-up receiver in a next-generation mobile communication system.

Additional aspects will be set forth in part in the description which follows and, in part, will be apparent from the description, or may be learned by practice of the presented embodiments.

In accordance with an aspect of the disclosure, a method performed by a terminal in a wireless communication system is provided. The method includes receiving, from a base station, configuration information on a cell reselection, preforming a measurement based on the configuration information using a main radio (MR) of the terminal, and in case that a result of the measurement is higher than a predetermined threshold, determining to relax the measurement using the MR of the terminal.

In an embodiment of the disclosure, the method further includes performing a measurement based on the configuration information using a low power wakeup signal receiver (LR) of the terminal, and in case that a result of the measurement using the LR of the terminal satisfies predetermined condition, determining that the result of the measurement using the LR of the terminal is offloaded to the result of the measurement using the MR of the terminal.

In an embodiment of the disclosure, the method further includes transmitting, to the base station, capability information on the terminal including at least one of information indicating whether the terminal supports relaxed measurement using the MR or information indicating whether the terminal supports a low power wakeup signal receiver (LR) of the terminal.

In an embodiment of the disclosure, the configuration information is received via system information.

In an embodiment of the disclosure, the terminal is in an idle state or an inactive state.

In an embodiment of the disclosure, the predetermined condition includes at least one of whether the result of the measurement using the LR is higher than a first threshold, whether the result of the measurement using the LR is lower than a second threshold, or whether the result of the measurement using the LR is higher than the first threshold and lower than the second threshold.

In an embodiment of the disclosure, the result of the measurement includes at least one of a cell selection quality value or a cell selection receiving level value.

In accordance with another aspect of the disclosure, a terminal in a wireless communication system is provided. The terminal includes a transceiver and a controller coupled with the transceiver and configured to receive, from a base station, configuration information on a cell reselection, preform a measurement based on the configuration information using a main radio (MR) of the terminal, and in case that a result of the measurement is higher than a predetermined threshold, determine to relax the measurement using the MR of the terminal.

In an embodiment of the disclosure, the controller is further configured to perform a measurement based on the configuration information using a low power wakeup signal receiver (LR) of the terminal, and in case that a result of the measurement using the LR of the terminal satisfies predetermined condition, determine that the result of the measurement using the LR of the terminal is offloaded to the result of the measurement using the MR of the terminal.

In an embodiment of the disclosure, the controller is further configured to transmit, to the base station, capability information on the terminal including at least one of information indicating whether the terminal supports relaxed measurement using the MR or information indicating whether the terminal supports a low power wakeup signal receiver (LR) of the terminal.

According to an embodiment of the disclosure, a method and an apparatus for measuring a serving cell of a UE supporting a low-power wake-up receiver in a next-generation mobile communication system are provided.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1A illustrates a structure of a long term evolution (LTE) system according to an embodiment of the disclosure;

FIG. 1B illustrates a radio protocol structure of an LTE system according to an embodiment of the disclosure;

FIG. 1C illustrates a structure of a next-generation mobile communication system according to an embodiment of the disclosure;

FIG. 1D illustrates a radio protocol structure of a next-generation mobile communication system according to an embodiment of the disclosure;

FIG. 1E illustrates a UE in a radio resource control (RRC) idle mode (RRC_IDLE) or an RRC inactive state (RRC_INACTIVE) performs a cell reselection evaluation process in a next-generation mobile communication system according to an embodiment of the disclosure;

FIG. 1F illustrates a UE supporting a low-power wake-up receiver replaces a serving cell measurement result of a main radio with a serving cell measurement result derived through a low-power wake-up receiver and performs frequency measurement for cell reselection in a next-generation mobile communication system according to an embodiment of the disclosure;

FIG. 1G illustrates a UE supporting a low-power wake-up receiver replaces a serving cell measurement result of a main radio with a serving cell measurement result derived through a low-power wake-up receiver or derives a serving cell measurement result of a main radio on a longer cycle in a next-generation mobile communication system according to an embodiment of the disclosure;

FIG. 1H is a block diagram illustrating an internal structure of a UE according to an embodiment of the disclosure; and

FIG. 1I is a block diagram illustrating a structure of a base station according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The terms which will be described below are terms defined based on the functions in the disclosure, and may be different according to users, intentions of the users, or customs. Therefore, the definitions of the terms should be made based on the contents throughout the specification.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as described below, and other terms referring to subjects having equivalent technical meanings may also be used.

In the following description, terms and names defined in the 3rd generation partnership project long term evolution (3GPP LTE) standards will be used for the sake of descriptive convenience. However, the disclosure is not limited by these terms and names, and may be applied in the same way to systems that conform other standards. In the disclosure, the term “eNB” may be interchangeably used with the term “gNB” for the sake of descriptive convenience. For example, a base station described as “eNB” may refer to “gNB”.

A terminal may include a user equipment (UE), a mobile station (MS), a cellular phone, a smartphone, a computer, or a multimedia system capable of performing a communication function. In the disclosure, a “downlink (DL)” may refer to a radio link via which a base station transmits a signal to a terminal, and an “uplink (UL)” may refer to a radio link via which a terminal transmits a signal to a base station. Furthermore, in the following description, LTE or LTE-advanced (LTE-A) systems may be described by way of example, but the embodiments of the disclosure may also be applied to other communication systems having similar technical backgrounds or channel types. Examples of such communication systems may include the 5th generation mobile communication technologies (5G, new radio, and NR) developed beyond LTE-A, and in the following description, the “5G” may be the concept that covers the exiting LTE, LTE-A, or other similar services. In addition, based on determinations by those skilled in the art, the disclosure may also be applied to other communication systems through some modifications without significantly departing from the scope of the disclosure. Herein, it will be understood that each block of the flowchart illustrations, and combinations of blocks in the flowchart illustrations, can be implemented by computer program instructions.

These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved. As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card. Furthermore, the “unit” in embodiments may include one or more processors.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

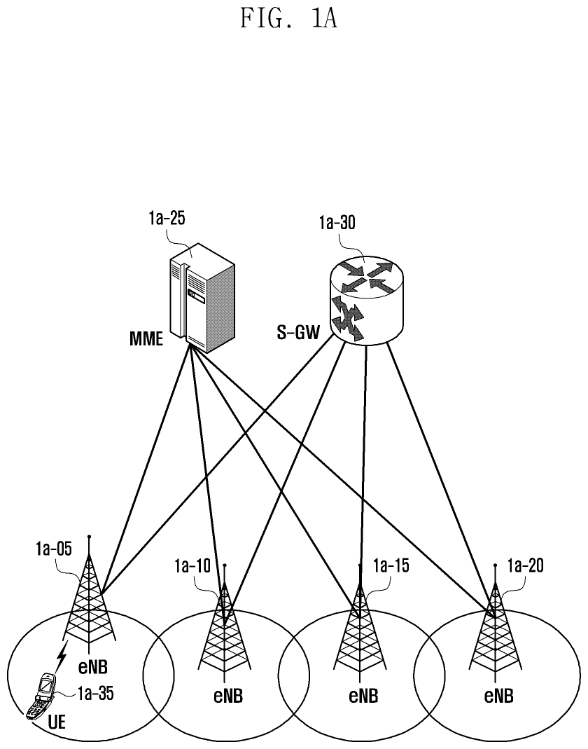

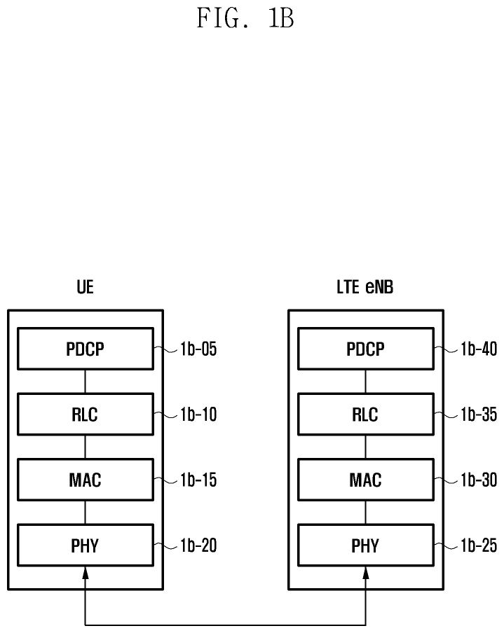

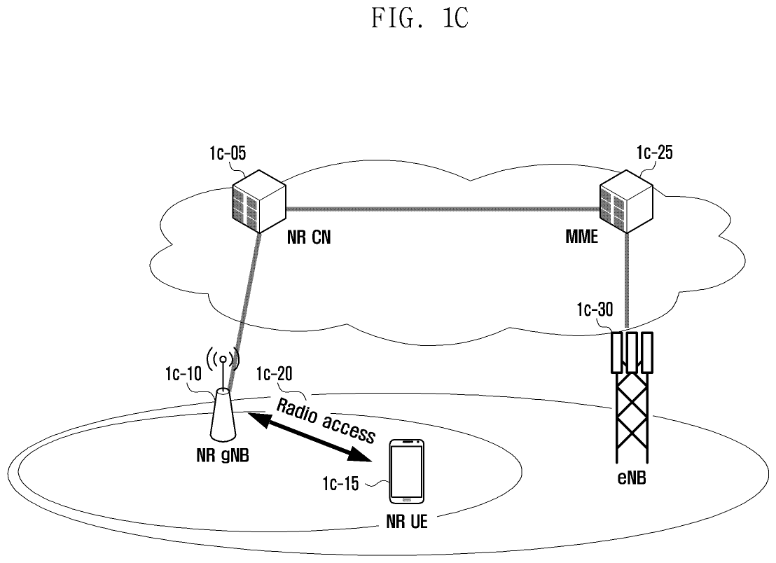

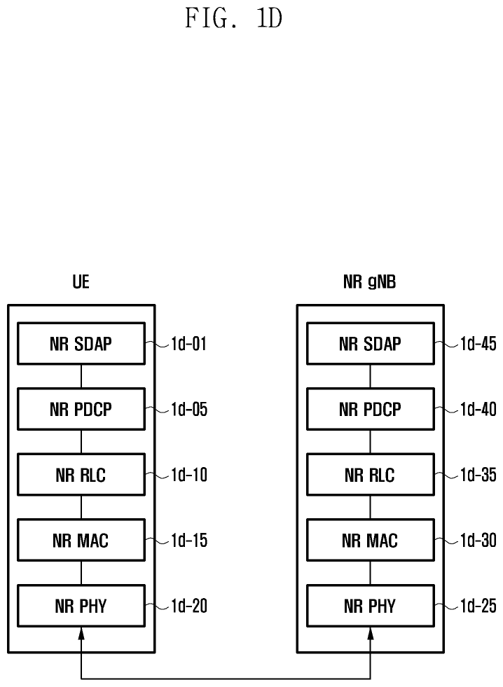

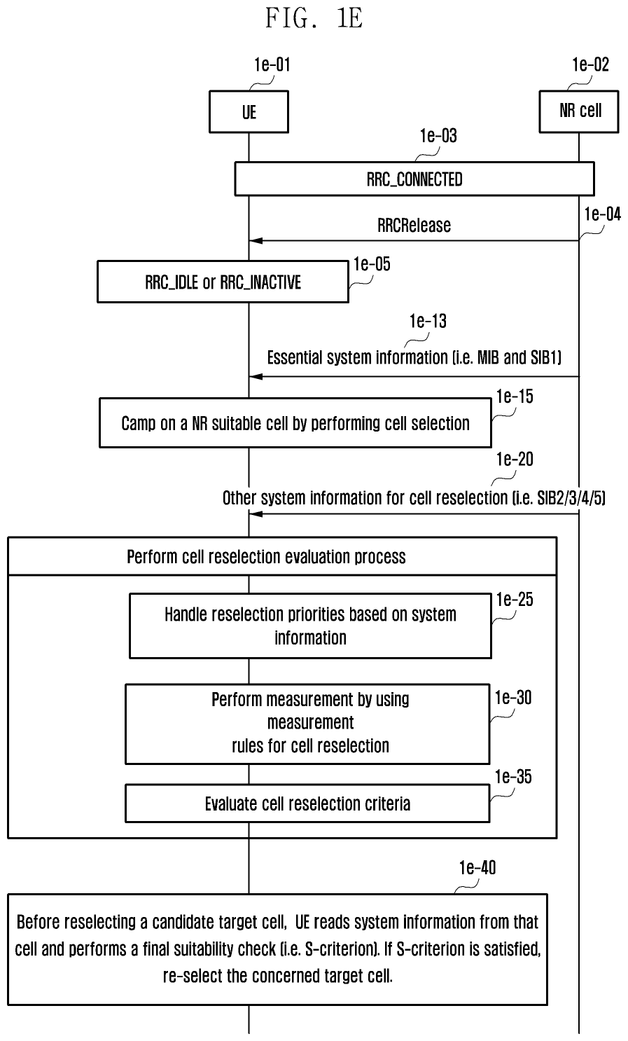

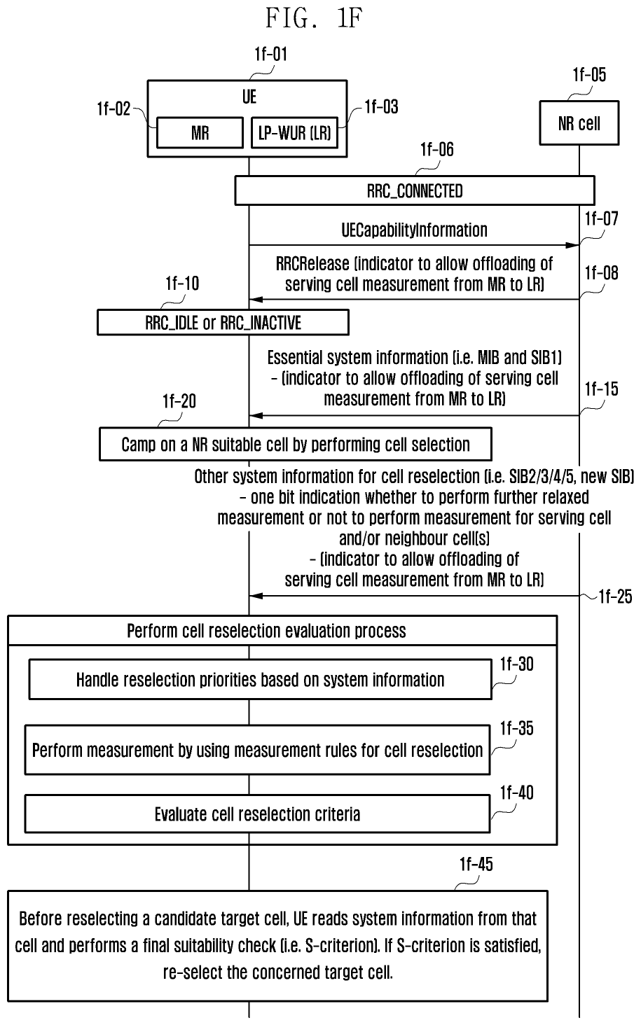

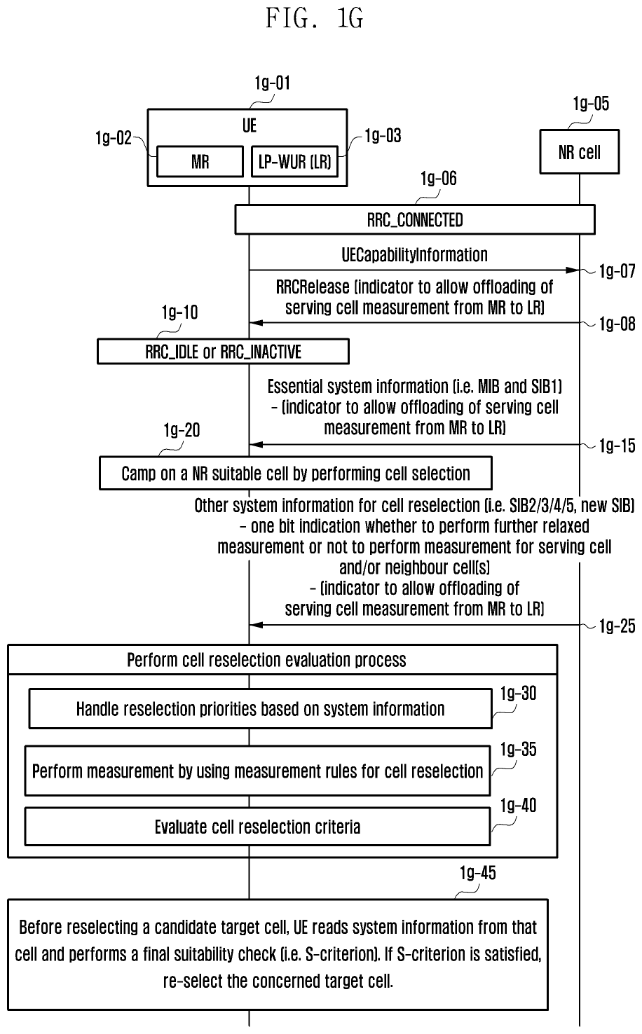

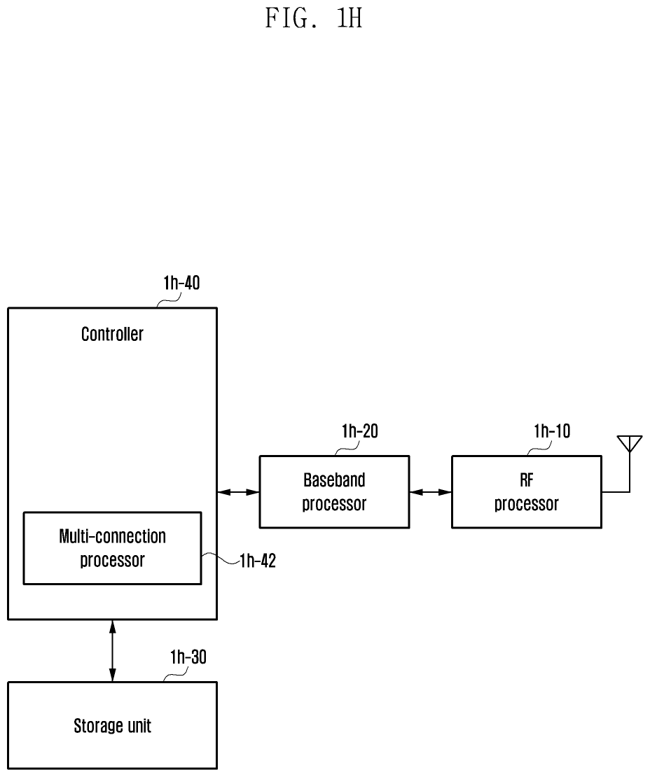

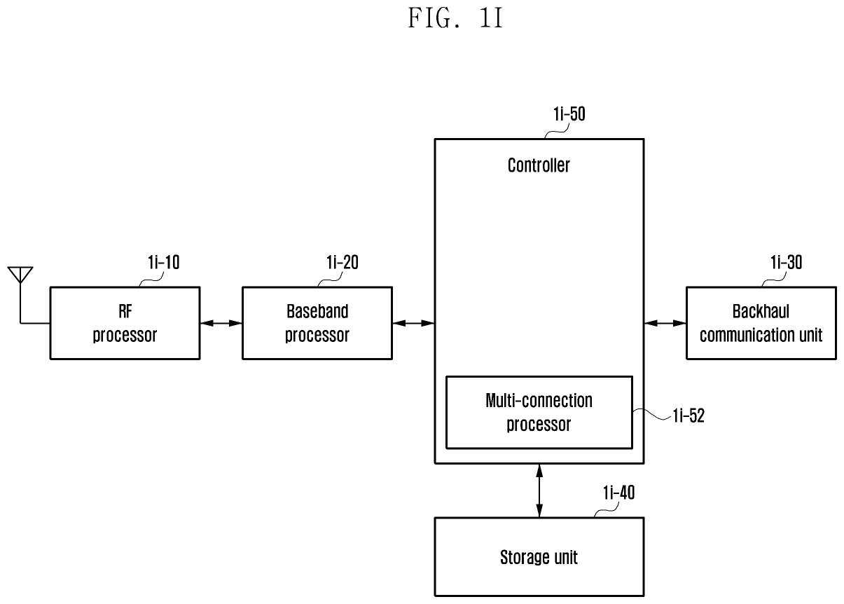

FIG. 1A illustrates a structure of an LTE system according to an embodiment of the disclosure.

Referring to FIG. 1A, a radio access network of an LTE system may include next-generation base stations (evolved node Bs, hereinafter ENBs, node Bs, or base stations) 1a-05, 1a-10, 1a-15, and 1a-20, a mobility management entity (MME) 1a-25, and a serving gateway (S-GW) 1a-30. A user equipment (hereinafter UE or terminal) 1a-35 may access an external network through the ENBs 1a-05 to 1a-20 and the S-GW 1a-30.

In FIG. 1A, the ENBs 1a-05 to 1a-20 each correspond to a node B of the related art in a universal mobile telecommunications system (UMTS) system. The ENBs 1a-05 to 1a-20 are connected to the UE 1a-35 through a radio channel, and perform more complicated roles than the node Bs of the related art. In the LTE system, since all user traffic including real-time services, such as voice over Internet protocol (IP) (VOIP) via the Internet protocol, is serviced through a shared channel, a device that collects state information, such as buffer states, available transmit power states, and channel states of UEs, and performs scheduling accordingly is required, and the ENBs 1a-05 to 1a-20 serve as the device. In general, one ENB 1a-05 to 1a-20 controls multiple cells. For example, in order to implement a transfer rate of 100 Mbps, the LTE system may use orthogonal frequency division multiplexing (hereinafter referred to as OFDM) as a radio access technology in a bandwidth of, for example, 20 MHz. Furthermore, the LTE system employs an adaptive modulation & coding (hereinafter referred to as AMC) scheme for determining a modulation scheme and a channel coding rate according to a channel state of a UE 1a-30. The S-GW 1a-30 is a device that provides a data bearer, and may generate or remove a data bearer under the control of the MME 1a-25. The MME 1a-25 is a device responsible for various control functions as well as a mobility management function for a UE 1a-30, and is connected to multiple base stations 1a-05 to 1a-20.

FIG. 1B illustrates a radio protocol structure of an LTE system according to an embodiment of the disclosure.

Referring to FIG. 1B, a radio protocol of an LTE system includes a packet data convergence protocol (PDCP) 1b-05 or 1b-40, a radio link control (RLC) 1b-10 or 1b-35, and a medium access control (MAC) 1b-15 or 1b-30 on each of UE and ENB sides.

The packet data convergence protocol (PDCP) 1b-05 or 1b-40 is responsible for operations, such as IP header compression/reconstruction. The main functions of the PDCP 1b-05 or 1b-40 may be summarized as follows.
Header compression and decompression: robust header compression (ROHC) only
Transfer of user data
In-sequence delivery of upper layer protocol data units (PDUs) at PDCP re-establishment procedure for RLC acknowledged mode (AM)
For split bearers in DC (only support for RLC AM): PDCP PDU routing for transmission and PDCP PDU reordering for reception
Duplicate detection of lower layer service data units (SDUs) at PDCP re-establishment procedure for RLC AM
Retransmission of PDCP SDUs at handover and, for split bearers in DC, of PDCP PDUs at PDCP data-recovery procedure, for RLC AM
Ciphering and deciphering
Timer-based SDU discard in uplink

The radio link control (hereinafter referred to as RLC) 1b-10 or 1b-35 reconfigures a PDCP protocol data unit (PDU) into an appropriate size to perform an automatic repeat request (ARQ) operation. The main functions of the RLC 1b-10 or 1b-35 may be summarized as follows.
Transfer of upper layer PDUs
Error correction through ARQ (only for AM data transfer)
Concatenation, segmentation and reassembly of RLC SDUs (only for unacknowledged mode (UM) and AM data transfer)
Re-segmentation of RLC data PDUs (only for AM data transfer)
Reordering of RLC data PDUs (only for UM and AM data transfer)
Duplicate detection (only for UM and AM data transfer)
Protocol error detection (only for AM data transfer)
RLC SDU discard (only for UM and AM data transfer)
RLC re-establishment

The MAC 1b-15 or 1b-30 is connected to several RLC layer devices configured in a single terminal, and performs operations of multiplexing RLC PDUs to a MAC PDU and demultiplexing a MAC PDU to RLC PDUs. The main functions of the MAC 1b-15 or 1b-30 are summarized as follows.
Mapping between logical channels and transport channels
Multiplexing/demultiplexing of MAC SDUs belonging to one or different logical channels into/from transport blocks (TB) delivered to/from the physical layer on transport channels
Scheduling information reporting
Error correction through hybrid ARQ (HARQ)
Priority handling between logical channels of one UE
Priority handling between UEs by means of dynamic scheduling
Multimedia broadcast multicast service (MBMS) service identification
Transport format selection
Padding

A physical layer 1b-20 or 1b-25 performs operations of channel-coding and modulating upper layer data, thereby obtaining OFDM symbols, and delivering the same through a radio channel, or demodulating OFDM symbols received through the radio channel, channel-decoding the same, and delivering the same to the upper layer.

FIG. 1C illustrates a structure of a next-generation mobile communication system according to an embodiment of the disclosure.

Referring to FIG. 1C, a radio access network of a next-generation mobile communication system (hereinafter NR or 5G) includes a next-generation base station (new radio node B, hereinafter NR gNB or NR base station) 1c-10, and a new radio core network (NR CN) 1c-05. A user terminal (new radio user equipment, hereinafter NR UE or NR terminal) 1c-15 may access an external network via the NR gNB 1c-10 and the NR CN 1c-05.

In FIG. 1C, the NR gNB 1c-10 corresponds to an evolved node B (eNB) of a LTE system of the related art. The NR gNB 1c-10 may be connected to the NR UE 1c-15 through a radio channel 1c-20 and may provide outstanding services as compared to a node B of the related art. In the next-generation mobile communication system, since all user traffic is serviced through a shared channel, a device that collects state information, such as buffer statuses, available transmit power states, and channel states of UEs 1c-15, and performs scheduling accordingly is required, and the NR gNB 1c-10 serves as the device. In general, one NR gNB 1c-10 may control multiple cells. In order to implement ultrahigh-speed data transfer beyond the current LTE, the next-generation mobile communication system may provide a wider bandwidth than the existing maximum bandwidth, may employ an orthogonal frequency division multiplexing (hereinafter referred to as OFDM) as a radio access technology, and may additionally integrate a beamforming technology therewith. Furthermore, the next-generation mobile communication system may employ an adaptive modulation & coding (hereinafter referred to as AMC) scheme for determining a modulation scheme and a channel coding rate according to a channel state of a UE. The NR CN 1c-05 may perform functions, such as mobility support, bearer configuration, and quality of service (QoS) configuration. The NR CN 1c-05 is a device responsible for various control functions as well as a mobility management function for a UE 1c-15, and may be connected to multiple base stations 1c-10. In addition, the next-generation mobile communication system may interwork with the existing LTE system, and the NR CN 1c-05 may be connected to an MME 1c-25 via a network interface. The MME 1c-25 may be connected to an eNB 1c-30 that is an existing base station.

FIG. 1D illustrates a radio protocol structure of a next-generation mobile communication system according to an embodiment of the disclosure.

Referring to FIG. 1D, a radio protocol of a next-generation mobile communication system includes an NR service data adaptation protocol (SDAP) 1d-01 or 1d-45, an NR PDCP 1d-05 or 1d-40, an NR RLC 1d-10 or 1d-35, an NR MAC 1d-15 or 1d-30, and 1d-20 or 1d-25 on each of UE and NR gNB sides.

The main functions of the NR SDAP 1d-01 or 1d-45 may include some of functions below.
Transfer of user plane data
Mapping between a QoS flow and a DRB for both DL and UL
Marking QoS flow ID in both DL and UL packets
Reflective QoS flow to DRB mapping for UL SDAP PDUs

With regard to the SDAP layer device, the UE may be configured, through an RRC message, whether to use the header of the SDAP layer device or whether to use functions of the SDAP layer device for each PDCP layer device or each bearer or each logical channel, and if an SDAP header is configured, the non-access stratum (NAS) QoS reflection configuration 1-bit indicator (NAS reflective QoS) and the AS QoS reflection configuration 1-bit indicator (AS reflective QoS) of the SDAP header may be indicated so that the UE can update or reconfigure mapping information regarding the QoS flow and data bearer of the uplink and downlink. The SDAP header may include QoS flow ID information indicating the QoS. The QoS information may be used as data processing priority, scheduling information, or the like, for smoothly supporting services.

The main functions of the NR PDCP 1d-05 or 1d-40 may include some of functions below.
Header compression and decompression: robust header compression (ROHC) only
Transfer of user data
In-sequence delivery of upper layer PDUs
Out-of-sequence delivery of upper layer PDUs
PDCP PDU reordering for reception
Duplicate detection of lower layer SDUs
Retransmission of PDCP SDUs
Ciphering and deciphering
Timer-based SDU discard in uplink

The reordering of the NR PDCP device refers to a function of reordering PDCP PDU received from a lower layer in an order based on PDCP sequence numbers (SNs), and may include a function of transferring data to an upper layer according to a rearranged order, may include a function of directly transferring data without considering order, may include a function of rearranging order to record lost PDCP PDUs, may include a function of reporting the state of lost PDCP PDUs to a transmission side, or may include a function of requesting retransmission of lost PDCP PDUs.

The main functions of the NR RLC 1d-10 or 1d-35 may include some of functions below.
Transfer of upper layer PDUs
In-sequence delivery of upper layer PDUs
Out-of-sequence delivery of upper layer PDUs
Error Correction through ARQ
Concatenation, segmentation and reassembly of RLC SDUs
Re-segmentation of RLC data PDUs
Reordering of RLC data PDUs
Duplicate detection
Protocol error detection
RLC SDU discard
RLC re-establishment

The in-sequence delivery of the NR RLC device refers to a function of transferring RLC SDUs received from a lower layer to an upper layer in sequence, and may include a function of, if one original RLC SDU is divided into several RLC SDUs and then the RLC SDUs are received, reassembling the several RLC SDUs and transferring the reassembled RLC SDUs, may include a function of rearranging received RLC PDUs with reference to RLC sequence numbers (SNs) or PDCP sequence numbers (SNs), may include a function of rearranging order to record lost RLC PDUs, may include a function of reporting the state of lost RLC PDUs to a transmission side, may include a function of requesting retransmission of lost RLC PDUs, may include a function of, if there is a lost RLC SDU, sequentially transferring only RLC SDUs before the lost RLC SDU to an upper layer, may include a function of, although there is a lost RLC SDU, if a predetermined timer has expired, sequentially transferring, to an upper layer, all the RLC SDUs received before the timer is started, or may include a function of, although there is a lost RLC SDU, if a predetermined timer has expired, sequentially transferring all the RLC SDUs received up to the current, to an upper layer. In addition, the in-sequence delivery of the NR RLC device may include a function of processing RLC PDUs in the received order (regardless of the sequence number order, in the order of arrival) and delivering same to the PDCP device regardless of the order (out-of-sequence delivery), and may include a function of, in the case of segments, receiving segments which are stored in a buffer or which are to be received later, reconfiguring same into one complete RLC PDU, processing, and delivering same to the PDCP device. The NR RLC layer may include no concatenation function, which may be performed in the NR MAC layer or replaced with a multiplexing function of the NR MAC layer.

The out-of-sequence delivery of the NR RLC device refers to a function of instantly delivering RLC SDUs received from the lower layer to the upper layer regardless of the order, may include a function of, if multiple RLC SDUs received, into which one original RLC SDU has been segmented, are received, reassembling and delivering the same, and may include a function of storing the RLC SN or PDCP SN of received RLC PDUs, and recording RLC PDUs lost as a result of reordering.

The NR MAC 1d-15 or 1d-30 may be connected to multiple NR RLC layer devices configured in one UE, and the main functions of the NR MAC may include some of functions below.
Mapping between logical channels and transport channels
Multiplexing/demultiplexing of MAC SDUs
Scheduling information reporting
Error correction through HARQ
Priority handling between logical channels of one UE
Priority handling between UEs by means of dynamic scheduling
MBMS service identification
Transport format selection
Padding

An NR PHY layer 1b-20 or 1b-25 may perform operations of channel-coding and modulating upper layer data, thereby obtaining OFDM symbols, and delivering the same through a radio channel, or demodulating OFDM symbols received through the radio channel, channel-decoding the same, and delivering the same to the upper layer.

FIG. 1E illustrates a UE in an RRC idle mode (RRC_IDLE) or an RRC inactive state (RRC_INACTIVE) performs a cell reselection evaluation process in a next-generation mobile communication system according to an embodiment of the disclosure.

The cell reselection evaluation process may refer to a process in which the UE in the radio resource control (RRC) idle state (mode) (RRC_IDLE) or RRC inactive state (mode) (RRC_INACTIVE) determines whether to maintain a current serving cell or to reselect a neighbor cell when the service quality of the serving cell on which the UE is currently camps becomes lower than the service quality of the neighbor cell due to a predetermined reason or a movement.

In a handover, a network (access and mobility management function (AMF) or source gNB) determines whether to perform a handover operation. However, in cell reselection, the UE in the RRC idle mode or RRC inactive state may autonomously determine whether to perform a cell reselection operation, based on a cell measurement value. A cell to be reselected by the UE may refer to a cell using the same NR frequency (NR intra-frequency or serving NR frequency) as that of the serving cell on which the UE is currently camping, a cell using a different NR frequency (NR inter-frequency) from that of the serving cell, or a cell on a frequency (inter-RAT frequency) using a different radio access technology (RAT). Further, in describing the following embodiments of the disclosure, the term “cell” may refer to a base station controlling a cell, and the term “base station” may refer to a cell controlled by the base station.

Referring to FIG. 1E, a UE 1e-01 may establish an RRC connection with an NR cell 1e-02 to be in an RRC connected state (mode) (RRC_CONNECTED) (operation 1e-03).

The NR cell (base station) 1e-02 may transmit an RRC connection release message (RRCRelease) to the UE 1e-01 to release the RRC connection with the UE 1e-01 in the RRC connected mode (operation 1e-04). When the message includes suspension configuration information (suspendConfig), the UE 1e-01 may transition to the RRC inactive mode (RRC_INACTIVE) (operation 1e-05). When the message does not include suspendConfig, the UE 1e-01 may transition to the RRC idle mode (RRC_IDLE) (operation 1e-05). The message may include cellReselectionPriorities for the UE 1e-01 to perform cell reselection. cellReselectionPriorities may store at least one value among freqPriorityListEUTRA, freqPriorityListNR, and t320. When the value of t320 is included, the UE 1e-01 may drive a T320 timer with the value. Specifically, the configuration information included in the RRCRelease message may be as shown below in Table 1.

TABLE 1
RRCRelease ::= SEQUENCE {
rrc-TransactionIdentifier RRC-TransactionIdentifier,
criticalExtensions CHOICE {
rrcReleaseRRCRelease-IEs,
criticalExtensionsFuture SEQUENCE { }
}
}
RRCRelease-IEs ::= SEQUENCE {

| | |
|---|---|
| redirectedCarrierInfoRedirectedCarrierInfo | OPTIONAL, |

-- Need N

| | |
|---|---|
| cellReselectionPrioritiesCellReselectionPriorities | OPTIONAL, |

-- Need R

| | |
|---|---|
| suspendConfigSuspendConfig | OPTIONAL, -- |

Need R
deprioritisationReq SEQUENCE {
deprioritisationType ENUMERATED {frequency, nr},
deprioritisationTimer ENUMERATED {min5, min10, min15, min30}

| | |
|---|---|
| } | OPTIONAL, -- |

Need N

| | |
|---|---|
| lateNonCriticalExtension | OCTET STRING |

OPTIONAL,
nonCriticalExtension RRCRelease-v1540-IEs
OPTIONAL
}
RRCRelease-v1540-IEs ::= SEQUENCE {
waitTimeRejectWaitTime OPTIONAL, -- Need N
nonCriticalExtension RRCRelease-v1610-IEs OPTIONAL
}
RedirectedCarrierInfo ::= CHOICE {
nr CarrierInfoNR,
eutraRedirectedCarrierInfo-EUTRA,
...
}
RedirectedCarrierInfo-EUTRA ::= SEQUENCE {
eutraFrequency ARFCN-ValueEUTRA,

| | |
|---|---|
| cnType ENUMERATED {epc,fiveGC} | OPTIONAL |

-- Need N
}
CarrierInfoNR ::= SEQUENCE {
carrierFreq ARFCN-ValueNR,
ssbSubcarrierSpacingSubcarrierSpacing,

| | |
|---|---|
| smtc SSB-MTC | OPTIONAL, |

-- Need S
...
}
SuspendConfig ::= SEQUENCE {
fullI-RNTI I-RNTI-Value,
shortI-RNTI ShortI-RNTI-Value,
ran-PagingCyclePagingCycle,
ran-NotificationAreaInfo RAN-NotificationAreaInfo
OPTIONAL, -- Need M

| | |
|---|---|
| t380 PeriodicRNAU-TimerValue | OPTIONAL, |

-- Need R
nextHopChainingCountNextHopChainingCount,
...,
[[

| | |
|---|---|
| sl-ServingCellInfo-r17 SL-ServingCellInfo-r17 | OPTIONAL, |

-- Cond L2RemoteUE
sdt-Config-r17 SetupRelease { SDT-Config-r17 }
OPTIONAL, -- Need M
srs-PosRRC-InactiveConfig-r17 SRS-PosRRC-InactiveConfig-r17OPTIONAL, --
Need M
ran-ExtendedPagingCycle-r17 ExtendedPagingCycle-r17
OPTIONAL -- Need R
]]
}
PeriodicRNAU-TimerValue ::= ENUMERATED { min5, min10, min20, min30,
min60, min120, min360, min720}
CellReselectionPriorities ::= SEQUENCE {

| | |
|---|---|
| freqPriorityListEUTRAFreqPriorityListEUTRA | OPTIONAL, |

-- Need M

| | |
|---|---|
| freqPriorityListNRFreqPriorityListNR | OPTIONAL, - |

- Need M
t320 ENUMERATED {min5, min10, min20, min30, min60, min120,
min180, spare1} OPTIONAL, -- Need R
...,
[[
freqPriorityListNRSlicing-r17 FreqPriorityListNRSlicing-r17
OPTIONAL -- Need M
]]
}
PagingCycle ::= ENUMERATED {rf32, rf64, rf128, rf256}
ExtendedPagingCycle-r17 ::= ENUMERATED {rf256, rf512, rf1024, spare1}
FreqPriorityListEUTRA ::= SEQUENCE (SIZE (1..maxFreq)) OF
FreqPriorityEUTRA
FreqPriorityListNR ::= SEQUENCE (SIZE (1..maxFreq)) OF FreqPriorityNR
FreqPriorityEUTRA ::= SEQUENCE {
carrierFreq ARFCN-ValueEUTRA,
cellReselectionPriorityCellReselectionPriority,

| | |
|---|---|
| cellReselectionSubPriorityCellReselectionSubPriority | OPTIONAL |

-- Need R
}
FreqPriorityNR ::= SEQUENCE {
carrierFreq ARFCN-ValueNR,
cellReselectionPriorityCellReselectionPriority,

| | |
|---|---|
| cellReselectionSubPriorityCellReselectionSubPriority | OPTIONAL |

-- Need R
}
RAN-NotificationAreaInfo ::= CHOICE {
cellList PLMN-RAN-AreaCellList,
ran-AreaConfigList PLMN-RAN-AreaConfigList,
...
}
PLMN-RAN-AreaCellList ::= SEQUENCE (SIZE (1.. maxPLMNIdentities)) OF
PLMN-RAN-AreaCell
PLMN-RAN-AreaCell ::= SEQUENCE {

| | |
|---|---|
| plmn-Identity PLMN-Identity | OPTIONAL, |

-- Need S
ran-AreaCells SEQUENCE (SIZE (1..32)) OF CellIdentity
}
PLMN-RAN-AreaConfigList ::= SEQUENCE (SIZE (1..maxPLMNIdentities)) OF
PLMN-RAN-AreaConfig
PLMN-RAN-AreaConfig ::= SEQUENCE {

| | |
|---|---|
| plmn-Identity PLMN-Identity | OPTIONAL, |

-- Need S
ran-Area SEQUENCE (SIZE (1..16)) OF RAN-AreaConfig
}
RAN-AreaConfig ::= SEQUENCE {
trackingAreaCodeTrackingAreaCode,
ran-AreaCodeList SEQUENCE (SIZE (1..32)) OF RAN-AreaCode
OPTIONAL -- Need R
}

In operation 1e-13, the UE 1e-01 in the RRC idle mode or RRC inactive state may obtain essential system information from the NR cell 1e-02. In the disclosure, a master information block (MIB) and system information block 1 (SIB1) may be referred to as the essential system information.

In operation 1e-15, the UE 1e-01 in the RRC idle mode or RRC inactive state may perform a cell selection procedure, based on the essential system information obtained in operation 1e-13. For example, the UE 1e-01 may discover a suitable NR cell belonging to a selected public land mobile network (PLMN) or stand-alone non-public network (SNPN), and may camp on the cell. The cell on which the UE 1e-01 camps may be referred to as a serving cell. In the disclosure, a cell that satisfies conditions illustrated below in Table 2 may be defined as a suitable cell, based on “3GPP Technical Specification 38.304: UE procedures in idle mode and RRC inactive state.”

TABLE 2
suitable cell:
For UE not operating in SNPN Access Mode, a cell is considered as suitable if the
following conditions are fulfilled:
-The cell is part of either the selected PLMN or the registered PLMN or PLMN of the
Equivalent PLMN list, and for that PLMN either:
-The PLMN-ID of that PLMN is broadcast by the cell with no associated CAG-IDs and
CAG-only indication in the UE for that PLMN (TS 23.501 [10]) is absent or false;
-Allowed CAG list in the UE for that PLMN (TS 23.501 [10]) includes a CAG-ID
broadcast by the cell for that PLMN;
-The cell selection criteria are fulfilled, see clause 5.2.3.2.
According to the latest information provided by NAS:
-The cell is not barred, see clause 5.3.1;
-The cell is part of at least one TA that is not part of the list of “Forbidden Tracking Areas
for Roaming” (TS 22.011 [18]), which belongs to a PLMN that fulfils the first bullet above.
For UE operating in SNPN Access Mode, a cell is considered as suitable if the following
conditions are fulfilled:
-The cell is part of either the selected SNPN or the registered SNPN of the UE;
-The cell selection criteria are fulfilled, see clause 5.2.3.2;
According to the latest information provided by NAS:
-The cell is not barred, see clause 5.3.1;
-The cell is part of at least one TA that is not part of the list of “Forbidden Tracking Areas
for Roaming” which belongs to either the selected SNPN or the registered SNPN of the
UE.

For reference, the UE 1e-01 may determine that cell selection criteria are fulfilled when values according to Equation 1 and Table 3 are satisfied.

$$Srxlev > 0 AND Squal > 0 \qquad Equation 1$$

$$Where$$

$$Srxlev = Qrxlevmeas - ( Qrxlev min + Qrxlev min offset ) - Pcompensation - Qoffsettemp ,$$

$$Squal = Qqualmeas - ( Qqual min + Qqual min offset ) - Qoffsettemp .$$

TABLE 3

| | |
|---|---|
| Srxlev | Cell selection RX level value (dB) |
| Squal | Cell selection quality value (dB) |
| Qoffsetₜₑₘₚ | Offset temporarily applied to a cell as specified in TS 38.331 [3] |
| | (dB) |
| Qᵣₓₗₑᵥₘₑₐₛ | Measured cell RX level value (RSRP) |
| Q_{qualmeas} | Measured cell quality value (RSRQ) |
| Qᵣₓₗₑᵥₘᵢₙ | Minimum required RX level in the cell (dBm). If the UE supports |
| | SUL frequency for this cell, Qᵣₓₗₑᵥₘᵢₙ is obtained from q- |
| | RxLevMinSUL, if present, in SIB1, SIB2 and SIB4, additionally, if |
| | Q_{rxlevminoffsetcellSUL} is present in SIB3 and SIB4 for the concerned cell, |
| | this cell specific offset is added to the corresponding Qrxlevmin to |
| | achieve the required minimum RX level in the concerned cell; |
| | else Qᵣₓₗₑᵥₘᵢₙ is obtained from q-RxLevMinin SIB1, SIB2 and SIB4, |
| | additionally, if Q_{rxlevminoffsetcell} is present in SIB3 and SIB4 for the |
| | concerned cell, this cell specific offset is added to the corresponding |
| | Qrxlevmin to achieve the required minimum RX level in the |
| | concerned cell. |
| Q_{qualmin} | Minimum required quality level in the cell (dB). Additionally, if |
| | Q_{qualminoffsetcell} is signaled for the concerned cell, this cell specific |
| | offset is added to achieve the required minimum quality level in the |
| | concerned cell. |
| Q_{rxlevminoffset} | Offset to the signaled Qᵣₓₗₑᵥₘᵢₙ taken into account in the Srxlev |
| | evaluation as a result of a periodic search for a higher priority PLMN |
| | while camped normally in a VPLMN, as specified in TS 23.122 [9]. |
| Q_{qualminoffset} | Offset to the signaled Q_{qualmin} taken into account in the Squal |
| | evaluation as a result of a periodic search for a higher priority PLMN |
| | while camped normally in a VPLMN, as specified in TS 23.122 [9]. |
| P_{compensation} | For FR1, if the UE supports the additionalPmax in the NR-NS- |
| | PmaxList, if present, in SIB1, SIB2 and SIB4: |
| | max(P_{EMAX1} − P_{PowerClass}, 0) − (min(P_{EMAX2}, P_{PowerClass}) − min(P_{EMAX1}, |
| | P_{PowerClass})) (dB); |
| | else: |
| | max(P_{EMAX1} − P_{PowerClass}, 0) (dB) |
| | For FR2, P_{compensation} is set to 0. |
| | For IAB-MT, P_{compensation} is set to 0. |
| P_{EMAX1}, P_{EMAX2} | Maximum TX power level of a UE may use when transmitting on |
| | the uplink in the cell (dBm) defined as P_{EMAX} in TS 38.101 [15]. If |
| | UE supports SUL frequency for this cell, P_{EMAX1} and P_{EMAX2} are |
| | obtained from the p-Max for SUL in SIB1 and NR-NS-PmaxList for |
| | SUL respectively in SIB1, SIB2 and SIB4 as specified in TS 38.331 |
| | [3], else P_{EMAX1} and P_{EMAX2} are obtained from the p-Max and NR- |
| | NS-PmaxList respectively in SIB1, SIB2 and SIB4 for normal UL as |
| | specified in TS 38.331 [3]. |
| P_{PowerClass} | Maximum RF output power of the UE (dBm) according to the UE |
| | power class as defined in TS 38.101-1 [15]. |

In operation 1e-20, the UE 1e-01 in the RRC idle mode or RRC inactive state may obtain system information (e.g., SIB2, SIB3, SIB4, and SIB5) including cell reselection information from the serving cell 1e-02 to perform a cell reselection evaluation process. SIB2 may include information/parameters commonly applied for the UE 1e-01 to reselect an NR intra-frequency, NR inter-frequency, or inter-RAT frequency cell and NR intra-frequency cell reselection information excluding information related to a neighbor NR intra-frequency cell. For example, SIB2 may include one cell reselection priority configuration information for a serving NR frequency (frequency to which the cell which the UE currently camps on belongs). The cell reselection priority configuration information may refer to cellReselectionPriority and cellReselectionSubPriority. Specifically, cellReselectionPriority may store an integer value (e.g., one integer value ranging from 0 to 7), and cellReselectionSubPriority may store a decimal value (e.g., one decimal value among 0.2, 0.4, 0.6, and 0.8). When both cellReselectionPriority and cellReselectionSubPriority are signaled, the UE 1e-01 may derive a cell reselection priority value by adding the two values. For reference, a larger cell reselection priority value means a higher priority. Specifically, the cell reselection configuration information broadcasted in SIB2 may be as shown below in Table 4.

TABLE 4
SIB2 ::= SEQUENCE {
cellReselectionInfoCommon SEQUENCE {
nrofSS-BlocksToAverage INTEGER (2..maxNrofSS-BlocksToAverage)
OPTIONAL, -- Need S

| | |
|---|---|
| absThreshSS-BlocksConsolidationThresholdNR | OPTIONAL, -- |

```
Need S
rangeToBestCellRangeToBestCell OPTIONAL, -- Need R
    q-Hyst ENUMERATED {
                    dB0, dB1, dB2, dB3, dB4, dB5, dB6, dB8, dB10,
                    dB12, dB14, dB16, dB18, dB20, dB22, dB24},
speedStateReselectionPars SEQUENCE {
mobilityStateParametersMobilityStateParameters,
      q-HystSF SEQUENCE {
        sf-Medium ENUMERATED {dB−6, dB−4, dB−2, dB0},
        sf-High ENUMERATED {dB−6, dB−4, dB−2, dB0}
      }
    } OPTIONAL, -- Need R
  ...
  },
cellReselectionServingFreqInfo SEQUENCE {
    s-NonIntraSearchPReselectionThreshold OPTIONAL, -- Need S
    s-NonIntraSearchQReselectionThresholdQ OPTIONAL, -- Need
S
threshServingLowPReselectionThreshold,
threshServingLowQReselectionThresholdQ OPTIONAL, -- Need R
cellReselectionPriorityCellReselectionPriority,
cellReselectionSubPriorityCellReselectionSubPriority OPTIONAL, --
Need R
    ...
  },
intraFreqCellReselectionInfo SEQUENCE {
    q-RxLevMin Q-RxLevMin,
```

| | |
|---|---|
| q-RxLevMinSUL Q-RxLevMin | OPTIONAL, |

-- Need R

| | |
|---|---|
| q-QualMin Q-QualMin | OPTIONAL, -- |

```
Need S
    s-IntraSearchPReselectionThreshold,
    s-IntraSearchQReselectionThresholdQ OPTIONAL, -- Need S
    t-ReselectionNR T-Reselection,
frequencyBandListMultiFrequencyBandListNR-SIB OPTIONAL, -- Need
S
frequencyBandListSULMultiFrequencyBandListNR-SIB OPTIONAL, --
Need R
    p-Max P-Max OPTIONAL, -- Need
S
smtc SSB-MTC OPTIONAL, -- Need S
```

| | |
|---|---|
| ss-RSSI-Measurement SS-RSSI-Measurement | OPTIONAL, |

-- Need R

| | |
|---|---|
| ssb-ToMeasure SSB-ToMeasure | OPTIONAL, -- |

```
Need S
deriveSSB-IndexFromCell BOOLEAN,
    ...,
    [[
```

| | |
|---|---|
| t-ReselectionNR-SF SpeedStateScaleFactors | OPTIONAL |

```
-- Need N
    ]],
    [[
```

| | |
|---|---|
| smtc2-LP-r16 SSB-MTC2-LP-r16 | OPTIONAL, |

```
-- Need R
    ssb-PositionQCL-Common-r16 SSB-PositionQCL-Relation-r16
OPTIONAL -- Cond SharedSpectrum
    ]]
  },
  ...
  [[
  relaxedMeasurement-r16 SEQUENCE {
    lowMobilityEvaluation-r16 SEQUENCE {
      s-SearchDeltaP-r16 ENUMERATED {
                        dB3, dB6, dB9, dB12, dB15,
                        spare3, spare2, spare1},
      t-SearchDeltaP-r16 ENUMERATED {
                        s5, s10, s20, s30, s60, s120, s180,
                        s240, s300, spare7, spare6, spare5,
                        spare4, spare3, spare2, spare1}
    } OPTIONAL, -- Need R
    cellEdgeEvaluation-r16 SEQUENCE {
      s-SearchThresholdP-r16 ReselectionThreshold,
```

| | |
|---|---|
| s-SearchThresholdQ-r16 ReselectionThresholdQ | OPTIONAL |

```
-- Need R
    } OPTIONAL, -- Need R
    combineRelaxedMeasCondition-r16 ENUMERATED {true}
OPTIONAL, -- Need R
```

| | |
|---|---|
| highPriorityMeasRelax-r16 ENUMERATED {true} | OPTIONAL |

```
-- Need R
  } OPTIONAL, -- Need R
  ]]
}
RangeToBestCell ::= Q-OffsetRange
```

SIB3 may include neighbor cell information/parameters for the UE 1e-01 in the RRC idle mode or RRC inactive state to reselect an NR intra-frequency cell. For example, SIB3 may broadcast an NR intra-frequency cell list (intraFreqNeighCellList) for reselecting an NR intra-frequency cell, a cell list from which NR intra-frequency cell reselection is allowed (intraFreqAllowedCellList), and a cell list from which NR intra-frequency cell reselection is not allowed (intraFreqExcludedCellList). Specifically, SIB3 may broadcast information illustrated below in Table 5.

TABLE 5
SIB3 ::= SEQUENCE {

| | |
|---|---|
| intraFreqNeighCellListIntraFreqNeighCellList | OPTIONAL, -- |

Need R

| | |
|---|---|
| intraFreqExcludedCellListIntraFreqExcludedCellList | OPTIONAL, |

-- Need R

| | |
|---|---|
| lateNonCriticalExtension OCTET STRING | OPTIONAL, |

```
  ...,
  [[
  intraFreqNeighCellList-v1610 IntraFreqNeighCellList-v1610
OPTIONAL, -- Need R
  intraFreqAllowedCellList-r16 IntraFreqAllowedCellList-r16
OPTIONAL, -- Cond SharedSpectrum2
  intraFreqCAG-CellList-r16 SEQUENCE (SIZE (1..maxPLMN)) OF
IntraFreqCAG-CellListPerPLMN-r16 OPTIONAL -- Need R
  ]]
}
IntraFreqNeighCellList ::= SEQUENCE (SIZE (1..maxCellIntra)) OF
IntraFreqNeighCellInfo
IntraFreqNeighCellList-v1610 ::= SEQUENCE (SIZE (1..maxCellIntra)) OF
IntraFreqNeighCellInfo-v1610
IntraFreqNeighCellInfo ::= SEQUENCE {
physCellIdPhysCellId,
  q-OffsetCell Q-OffsetRange,
```

| | |
|---|---|
| q-RxLevMinOffsetCell INTEGER (1..8) | OPTIONAL, - |

- Need R

| | |
|---|---|
| q-RxLevMinOffsetCellSUL INTEGER (1..8) | OPTIONAL, |

-- Need R

| | |
|---|---|
| q-QualMinOffsetCell INTEGER (1..8) | OPTIONAL, -- |

Need R
...
}
IntraFreqNeighCellInfo-v1610 ::= SEQUENCE {

| | |
|---|---|
| ssb-PositionQCL-r16 SSB-PositionQCL-Relation-r16 | OPTIONAL |

```
-- Cond SharedSpectrum2
}
IntraFreqExcludedCellList ::= SEQUENCE (SIZE (1..maxCellExcluded)) OF PCI-
Range
IntraFreqAllowedCellList-r16 ::= SEQUENCE (SIZE (1..maxCellAllowed)) OF PCI-
Range
IntraFreqCAG-CellListPerPLMN-r16 ::= SEQUENCE {
  plmn-IdentityIndex-r16 INTEGER (1..maxPLMN),
  cag-CellList-r16 SEQUENCE (SIZE (1..maxCAG-Cell-r16)) OF PCI
Range
}
```

SIB4 may include information/parameters for the UE 1e-01 in the RRC idle mode or RRC inactive state to reselect an NR inter-frequency cell. For example, SIB4 may broadcast one NR inter-frequency or a plurality of NR inter-frequencies, and may broadcast one cell reselection priority configuration information for each NR inter-frequency. The cell reselection priority configuration information for each NR inter-frequency may refer to the foregoing information (e.g., cellReselectionPriority and/or cellReselectionSubPriority mapped to each NR inter-frequency), and may be optionally broadcast. Specifically, SIB4 may broadcast information illustrated below in Table 6.

```
TABLE 6
SIB4 ::= SEQUENCE {
interFreqCarrierFreqListInterFreqCarrierFreqList,
lateNonCriticalExtension OCTET STRING OPTIONAL,
  ...,
  [[
  interFreqCarrierFreqList-v1610 InterFreqCarrierFreqList-v1610 OPTIONAL
-- Need R
  ]]
}
InterFreqCarrierFreqList ::= SEQUENCE (SIZE (1..maxFreq)) OF
Inter FreqCarrierFreqInfo
InterFreqCarrierFreqList-v1610 ::= SEQUENCE (SIZE (1..maxFreq)) OF
InterFreqCarrierFreqInfo-v1610
InterFreqCarrierFreqInfo ::= SEQUENCE {
  dl-CarrierFreq ARFCN-ValueNR,
```

| | |
|---|---|
| frequencyBandListMultiFrequencyBandListNR-SIB | OPTIONAL, -- |

Cond Mandatory

| | |
|---|---|
| frequencyBandListSULMultiFrequencyBandListNR-SIB | OPTIONAL, |

-- Need R
nrofSS-BlocksToAverage INTEGER (2..maxNrofSS-BlocksToAverage)
OPTIONAL, -- Need S

| | |
|---|---|
| absThreshSS-BlocksConsolidationThresholdNR | OPTIONAL, |

-- Need S
smtc SSB-MTC OPTIONAL, -- Need
S
ssbSubcarrierSpacingSubcarrierSpacing,

| | |
|---|---|
| ssb-ToMeasure SSB-ToMeasure | OPTIONAL, |

-- Need S
deriveSSB-IndexFromCell BOOLEAN,

| | |
|---|---|
| ss-RSSI-Measurement SS-RSSI-Measurement | OPTIONAL, |

-- Need R
q-RxLevMin Q-RxLevMin,

| | |
|---|---|
| q-RxLevMinSUL Q-RxLevMin | OPTIONAL, |

-- Need R

| | |
|---|---|
| q-QualMin Q-QualMin | OPTIONAL, - |

- Need S

| | |
|---|---|
| p-Max P-Max | OPTIONAL, -- |

```
Need S
  t-ReselectionNR T-Reselection,
  t-ReselectionNR-SF SpeedStateScaleFactorsOPTIONAL, -- Need S
threshX-HighPReselectionThreshold,
threshX-LowPReselectionThreshold,
thresh X-Q SEQUENCE {
threshX-HighQ ReselectionThresholdQ,
threshX-LowQReselectionThresholdQ
  } OPTIONAL, -- Cond
RSRQ
```

| | |
|---|---|
| cellReselectionPriorityCellReselectionPriority | OPTIONAL, -- |

Need R

| | |
|---|---|
| cellReselectionSubPriorityCellReselectionSubPriority | OPTIONAL, |

-- Need R

| | |
|---|---|
| q-OffsetFreq Q-OffsetRange | DEFAULT dB0, |
| interFreqNeighCellListInterFreqNeighCellList | OPTIONAL, -- |

Need R

| | |
|---|---|
| interFreqExcludedCellListInterFreqExcludedCellList | OPTIONAL, |

```
-- Need R
  ...
}
InterFreqCarrierFreqInfo-v1610 ::= SEQUENCE {
  interFreqNeighCellList-v1610 InterFreqNeighCellList-v1610
OPTIONAL, -- Need R
```

| | |
|---|---|
| smtc2-LP-r16 SSB-MTC2-LP-r16 | OPTIONAL, |

```
-- Need R
  interFreqAllowedCellList-r16 InterFreqAllowedCellList-r16
OPTIONAL, -- Cond SharedSpectrum2
  ssb-PositionQCL-Common-r16 SSB-PositionQCL-Relation-r16
OPTIONAL, -- Cond SharedSpectrum
  interFreqCAG-CellList-r16 SEQUENCE (SIZE (1..maxPLMN)) OF
InterFreqCAG-CellListPerPLMN-r16 OPTIONAL -- Need R
}
InterFreqNeighCellList ::= SEQUENCE (SIZE (1..maxCellInter)) OF
InterFreqNeighCellInfo
InterFreqNeighCellList-v1610 ::= SEQUENCE (SIZE (1..maxCellInter)) OF
InterFreqNeighCellInfo-v1610
InterFreqNeighCellInfo ::= SEQUENCE {
physCellIdPhysCellId,
  q-OffsetCell Q-OffsetRange,
```

| | |
|---|---|
| q-RxLevMinOffsetCell INTEGER (1..8) | OPTIONAL, |

-- Need R

| | |
|---|---|
| q-RxLevMinOffsetCellSUL INTEGER (1..8) | OPTIONAL, |

-- Need R

| | |
|---|---|
| q-QualMinOffsetCell INTEGER (1..8) | OPTIONAL, |

```
-- Need R
  ...
}
InterFreqNeighCellInfo-v1610 ::= SEQUENCE {
  ssb-PositionQCL-r16 SSB-PositionQCL-Relation-r16
OPTIONAL -- Cond SharedSpectrum2
}
InterFreqExcludedCellList ::= SEQUENCE (SIZE (1..maxCellExcluded)) OF PCI-
Range
InterFreqAllowedCellList-r16 ::= SEQUENCE (SIZE (1..maxCellAllowed)) OF PCI-
Range
InterFreqCAG-CellListPerPLMN-r16 ::= SEQUENCE {
  plmn-IdentityIndex-r16 INTEGER (1..maxPLMN),
  cag-CellList-r16 SEQUENCE (SIZE (1..maxCAG-Cell-r16)) OF PCI-Range
}
```

SIB5 may include information/parameters for the UE 1e-01 in the RRC idle mode or RRC inactive state to reselect an inter-RAT frequency cell. For example, SIB5 may broadcast one evolved UMTS terrestrial radio access (EUTRA) frequency or a plurality of EUTRA frequencies, and may broadcast one cell reselection priority configuration information for each EUTRA frequency. The cell reselection priority configuration information for each EUTRA frequency may refer to the foregoing information (e.g., cellReselectionPriority and/or cellReselectionSubPriority mapped to each EUTRA frequency), and may be optionally broadcast. Specifically, SIB5 may broadcast information illustrated below in Table 7.

TABLE 7
SIB5 ::= SEQUENCE {
carrierFreqListEUTRACarrierFreqListEUTRA OPTIONAL, -- Need
R
t-ReselectionEUTRA T-Reselection,

| | |
|---|---|
| t-ReselectionEUTRA-SF SpeedStateScaleFactors | OPTIONAL, |

-- Need S

| | |
|---|---|
| lateNonCriticalExtension OCTET STRING | OPTIONAL, |

```
  ...,
  [[
  carrierFreqListEUTRA-v1610 CarrierFreqListEUTRA-v1610
OPTIONAL -- Need R
  ]]
}
CarrierFreqListEUTRA ::= SEQUENCE (SIZE (1..maxEUTRA-Carrier)) OF
CarrierFreqEUTRA
CarrierFreqListEUTRA-v1610 ::= SEQUENCE (SIZE (1..maxEUTRA-Carrier)) OF
CarrierFreqEUTRA-v1610
CarrierFreqEUTRA ::= SEQUENCE {
carrierFreq ARFCN-ValueEUTRA,
```

| | |
|---|---|
| eutra-multiBandInfoList EUTRA-MultiBandInfoList | OPTIONAL, |

-- Need R

| | |
|---|---|
| eutra-FreqNeighCellList EUTRA-FreqNeighCellList | OPTIONAL, |

-- Need R

| | |
|---|---|
| eutra-ExcludedCellList EUTRA-FreqExcludedCellList | OPTIONAL, |

```
-- Need R
allowedMeasBandwidth EUTRA-AllowedMeasBandwidth,
  presenceAntennaPort1 EUTRA-PresenceAntennaPort1,
cellReselectionPriorityCellReselectionPriority OPTIONAL, -- Need R
cellReselectionSubPriorityCellReselectionSubPriority OPTIONAL, --
Need R
threshX-High ReselectionThreshold,
threshX-Low ReselectionThreshold,
  q-RxLevMin INTEGER (−70..−22),
  q-QualMin INTEGER (−34..−3),
  p-MaxEUTRA INTEGER (−30..33),
threshX-Q SEQUENCE {
threshX-HighQ ReselectionThresholdQ,
threshX-LowQReselectionThresholdQ
  } OPTIONAL -- Cond RSRQ
}
CarrierFreqEUTRA-v1610 ::= SEQUENCE {
```

| | |
|---|---|
| highSpeedEUTRACarrier-r16 ENUMERATED {true} | OPTIONAL |

-- Need R
}
EUTRA-FreqExcludedCellList ::= SEQUENCE (SIZE (1..maxEUTRA-
CellExcluded)) OF EUTRA-PhysCellIdRange
EUTRA-FreqNeighCellList ::= SEQUENCE (SIZE (1..maxCellEUTRA)) OF
EUTRA-FreqNeighCellInfo
EUTRA-FreqNeighCellInfo ::= SEQUENCE {
physCellId EUTRA-PhysCellId,
dummy EUTRA-Q-OffsetRange,

| | |
|---|---|
| q-RxLevMinOffsetCell INTEGER (1..8) | OPTIONAL, - |

- Need R

| | |
|---|---|
| q-QualMinOffsetCell INTEGER (1..8) | OPTIONAL - |

- Need R
}

The UE 1e-01 in the RRC idle mode or RRC inactive state may perform the cell reselection evaluation process. The cell reselection evaluation process may refer to a series of processes for reselecting a cell by performing reselection priorities handling, performing frequency measurement by applying measurement rules for cell reselection, and evaluating cell reselection criteria.

In operation 1e-25, the UE 1e-01 in the RRC idle mode or RRC inactive state may determine a reselection priority, based on the RRC release message received in operation 1e-04 or the system information received in operation 1e-20. When the RRC connection release message received in operation 1e-04 includes cellReselectionPriorities and there is no t320 timer value in cellReselectionPriorities or the T320 timer is running with the value of the t320 timer configured, the UE 1e-01 may determine a reselection priority according to the RRC connection release message. For example, when celllReselectionPriorities included in the RRC connection release message is applicable, the UE 1e-01 may determine the reselection priority according to the RRC connection release message. When the RRC connection release message does not include cellReselectionPriorities or cellReselectionPriorities is released, the UE 1e-01 may determine a reselection priority, based on the system information received in operation 1e-20. The UE 1e-01 according to the disclosure may determine, based on a cell reselection priority value mapped to the NR frequency to which the serving cell which the UE currently camps on belongs, whether each NR inter-frequency or inter-RAT frequency has the same cell reselection priority as that of the NR frequency to which the serving cell belongs, has a higher cell reselection priority than that of the NR frequency to which the serving cell belongs, or has a lower cell reselection priority than that of the NR frequency to which the serving cell belongs. For example, when the cell reselection priority value mapped to the NR frequency to which the serving cell which the UE currently camps on belongs is 3, the cell reselection priority value of NR inter-frequency 1 is 2, the cell reselection priority value of NR inter-frequency 2 is 3, the cell reselection priority value of NR inter-frequency 3 is 4, and the cell reselection priority value of EUTRA frequency 1 is 2 in the system information obtained in operation 1e-20 is 3, the UE 1e-01 may determine NR inter-frequency 1 and EUTRA frequency 1 as lower cell reselection priorities, determine NR inter-frequency 2 as an equal reselection priority (to that the NR frequency to which the serving cell which the UE currently camps on belongs), and determine NR inter-frequency 3 as a higher cell reselection priority.

In operation 1e-30, the UE 1e-01 in the RRC idle mode or RRC inactive state may perform frequency measurement for cell reselection. Here, the UE 1e-01 may perform frequency measurement using the following measurement rules according to the cell reselection priority determined in operation 1e-25 in order to minimize battery consumption.
The UE 1e-01 may not perform NR intra-frequency measurement when condition 1 below is satisfied. Otherwise (e.g., when condition 1 is not satisfied), the UE 1e-01 may perform NR intra-frequency measurement.
Condition 1: The reception level (Srxlev) of the serving cell is greater than a threshold value of SIntraSearchP and the reception quality (Squal) of the serving cell is greater than a threshold value of SIntraSearchQ (Serving cell fulfils Srxlev>SIntraSearchP and Squal>SIntraSearchQ).
For an NR inter-frequency or an inter-RAT frequency having a higher reselection priority than the NR frequency of the current serving cell, the UE 1e-01 may perform measurement according to 3GPP TS 38.133.
For an NR inter-frequency having a reselection priority lower than or equal to that of the NR frequency of the current serving cell and an inter-RAT frequency having a reselection priority lower than that of the NR frequency of the current serving cell, the UE 1e-01 may not perform measurement when condition 2 below is satisfied. Otherwise (e.g., when condition 2 is not satisfied), the UE 1e-01 may measure cells on the NR inter-frequency having the reselection priority lower than or equal to that of the NR frequency, or may measure cells on the inter-RAT frequency having the reselection priority lower than that of the NR frequency.
Condition 2: The reception level (Srxlev) of the serving cell is greater than a threshold value of SnonIntraSearchP and the reception quality (Squal) of the serving cell is greater than a threshold value of SnonIntraSearchQ (Serving cell fulfils Srxlev>SnonIntraSearchP and Squal>SnonIntraSearchQ).

For reference, the foregoing threshold values (SintraSearchP, SintraSearchQ, SnonIntraSearchP, and SnonintraSearchQ) may be broadcasted in the system information obtained in operation 1e-20.

When the UE 1e-01 supports relaxed measurement and relaxedMeasurement exists in SIB2, the UE 1e-01 may perform necessary measurement according to the foregoing content and relax according to Table 8 below.

TABLE 8

| | |
|---|---|
| - | if lowMobilityEvaluation is configured and cellEdgeEvaluationis not configured; |

and

| | |
|---|---|
| - | if the UE has performed normal intra-frequency, NR inter-frequency, or inter-RAT |

frequency measurements for at least T_{SearchDeltaP} after (re-)selecting a new cell; and

| | |
|---|---|
| - | if the relaxed measurement criterion in clause 5.2.4.9.1 is fulfilled for a period of |

T_{SearchDeltaP}:

| | |
|---|---|
| - | the UE may choose to perform relaxed measurements for intra-frequency cells, |

NR inter-frequency cells or inter-RAT frequency cells according to relaxation methods in
clauses 4.2.2.9, 4.2.2.10, 4.2.2.11, 4.2C.2.7 and 4.2C.2.8 in TS 38.133 [8];

| | |
|---|---|
| - | if cellEdgeEvaluationis configured and lowMobilityEvaluation is not configured; |

and

| | |
|---|---|
| - | if the relaxed measurement criterion in clause 5.2.4.9.2 is fulfilled: |
| - | the UE may choose to perform relaxed measurements for intra-frequency cells |

according to relaxation methods in clauses 4.2.2.9 and 4.2C.2.7 in TS 38.133 [8];

| | |
|---|---|
| - | if the serving cell fulfils Srxlev≤S_{nonIntraSearchP} or Squal≤S_{nonIntraSearchQ}: |
| - | the UE may choose to perform relaxed measurements for NR inter-frequency cells |

or inter-RAT frequency cells according to relaxation methods in clauses 4.2.2.10, 4.2.2.11
and 4.2C.2.8 in TS 38.133 [8];

| | |
|---|---|
| - | if both lowMobilityEvaluation and cellEdgeEvaluation are configured: |
| - | if the UE has performed normal intra-frequency, NR inter-frequency, or inter-RAT |

frequency measurements for at least T_{SearchDeltaP} after (re-)selecting a new cell; and

| | |
|---|---|
| - | if the relaxed measurement criterion in clause 5.2.4.9.1 is fulfilled for a period of |

T_{SearchDeltaP}; and

| | |
|---|---|
| - | if the relaxed measurement criterion in clause 5.2.4.9.2 is fulfilled: |
| - | the UE may choose to perform relaxed measurements for NR intra-frequency |

cells, inter-frequency cells or inter-RAT frequency cells according to relaxation methods
in clauses 4.2.2.9, 4.2.2.10, 4.2.2.11, 4.2C.2.7 and 4.2C.2.8 in TS 38.133 [8];

| | |
|---|---|
| - | else: |
| - | if the UE has performed normal intra-frequency, NR inter-frequency, or inter-RAT |

frequency measurements for at least T_{SearchDeltaP} after (re-)selecting a new cell, and the
relaxed measurement criterion in clause 5.2.4.9.1 is fulfilled for a period of T_{SearchDeltaP};
or,

| | |
|---|---|
| - | if the relaxed measurement criterion in clause 5.2.4.9.2 is fulfilled: |
| - | if combineRelaxedMeasCondition is not configured: |
| - | the UE may choose to perform relaxed measurements for intra-frequency cells, |

NR inter-frequency cells of equal or lower priority, or inter-RAT frequency cells of lower
priority according to relaxation methods in clauses 4.2.2.9, 4.2.2.10, 4.2.2.11, 4.2C.2.7
and 4.2C.2.8 in TS 38.133 [8];

| | |
|---|---|
| - | if the serving cell fulfils Srxlev<S_{nonIntraSearchP} or Squal≤S_{nonIntraSearchQ}: |
| - | the UE may choose to perform relaxed measurement for NR inter-frequency cells |

of higher priority, or inter-RAT frequency cells of higher priority according to relaxation
methods in clauses 4.2.2.10, 4.2.2.11 and 4.2C.2.8 in TS 38.133 [8];

| | |
|---|---|
| - | if the UE is a RedCap UE; and |
| - | if stationaryMobilityEvaluation is configured and |

cellEdgeEvaluationWhileStationary is not configured; and

| | |
|---|---|
| - | if the UE has performed normal intra-frequency, NR inter-frequency, or inter-RAT |

frequency measurements for at least T_{SearchDeltaP-Stationary} after (re-)selecting a new cell; and

| | |
|---|---|
| - | if the relaxed measurement criterion in clause 5.2.4.9.3 is fulfilled for a period of |

T_{SearchDeltaP-Stationary}:

| | |
|---|---|
| - | the UE may choose to perform relaxed measurements for intra-frequency cells, |

NR inter-frequency cells, or inter-RAT frequency cells according to relaxation methods
in clauses 4.2B.2.9, 4.2B.2.10, and 4.2B.2.11 in TS 38.133 [8];

| | |
|---|---|
| - | if the UE is a RedCap UE; and |
| - | if both stationaryMobilityEvaluation and cellEdgeEvaluationWhileStationary are |

configured:

| | |
|---|---|
| - | if the UE has performed normal intra-frequency, NR inter-frequency, or inter-RAT |

frequency measurements for at least T_{SearchDeltaP-Stationary} after (re-)selecting a new cell; and

| | |
|---|---|
| - | if the relaxed measurement criterion in clause 5.2.4.9.4 is fulfilled: |
| - | the UE may choose to perform relaxed measurements for intra-frequency cells, |

NR inter-frequency cells, or inter-RAT frequency cells according to relaxation methods
in clauses 4.2B.2.9, 4.2B.2.10, and 4.2B.2.11 in TS 38.133 [8];

| | |
|---|---|
| - | else: |
| - | if combineRelaxedMeasCondition2 is not configured: |
| - | if the UE has performed normal intra-frequency, NR inter-frequency, or inter-RAT |

frequency measurements for at least T_{SearchDeltaP-Stationary} after (re-)selecting a new cell; and

| | |
|---|---|
| - | if the relaxed measurement criterion in clause 5.2.4.9.3 is fulfilled for a period of |

T_{SearchDeltaP-Stationary}:

| | |
|---|---|
| - | the UE may choose to perform relaxed measurements for intra-frequency cells, |

NR inter-frequency cells, or inter-RAT frequency cells according to relaxation methods
in clauses 4.2B.2.9, 4.2B.2.10, and 4.2B.2.11 in TS 38.133 [8];

| | |
|---|---|
| NOTE 1: | It is up to UE implementation when to start performing relaxed |

measurements in RRC Idle/Inactive if multiple methods are configured.

| | |
|---|---|
| NOTE 2: | It is up to UE implementation which relaxation method to perform based |

on the “allowed” cases as specified in TS 38.133 [8] for RRC Idle/Inactive if multiple
methods are configured.
The above relaxed measurements and no measurement are not applicable for frequencies
that are included in VarMeasIdleConfig, if configured and for which the UE supports dual
connectivity or carrier aggregation between those frequencies and the frequency of the
current serving cell.

| | |
|---|---|
| 5.2.4.9.1 | Relaxed measurement criterion for UE with low mobility |

The relaxed measurement criterion for UE with low mobility is fulfilled when:

| | |
|---|---|
| - | (Srxlev_{Ref} − Srxlev) <S_{SearchDeltaP}, |

Where:

| | |
|---|---|
| - | Srxlev = current Srxlev value of the serving cell (dB). |
| - | Srxlev_{Ref} = reference Srxlev value of the serving cell (dB), set as follows: |
| - | After selecting or reselecting a new cell, or |
| - | If (Srxlev − Srxlev_{Ref}) > 0, or |
| - | If the relaxed measurement criterion has not been met for T_{SearchDeltaP}: |
| - | The UE shall set the value of Srxlev_{Ref} to the current Srxlev value of the serving |

cell.

| | |
|---|---|
| 5.2.4.9.2 | Relaxed measurement criterion for UE not at cell edge |

The relaxed measurement criterion for UE not at cell edge is fulfilled when:

| | |
|---|---|
| - | Srxlev>S_{SearchThresholdP}, and, |
| - | Squal>S_{SearchThresholdQ}, if S_{SearchThresholdQ} is configured, |

Where:

| | |
|---|---|
| - | Srxlev = current Srxlev value of the serving cell (dB). |
| - | Squal = current Squal value of the serving cell (dB). |
| 5.2.4.9.3 | Relaxed measurement criterion for a stationary RedCap UE |

The relaxed measurement criterion for a stationary RedCap UE is fulfilled when:

| | |
|---|---|
| - | (Srxlev_{RefStationary} − Srxlev) <S_{SearchDeltaP-Stationary}, |

Where:

| | |
|---|---|
| - | Srxlev = current Srxlev value of the serving cell (dB). |
| - | Srxlev_{RefStationary} = reference Srxlev value of the serving cell (dB), set as follows: |
| - | After selecting or reselecting a new cell, or |
| - | If (Srxlev − Srxlev_{RefStationary}) > 0, or |
| - | If the relaxed measurement criterion has not been met for T_{SearchDeltaP-Stationary}: |
| - | The UE shall set the value of Srxlev_{RefStationary} to the current Srxlev value of the |

serving cell.

| | |
|---|---|
| 5.2.4.9.4 | Relaxed measurement criterion for a stationary RedCap UE not at cell |

edge
The relaxed measurement criterion for a stationary RedCap UE not at cell edge is fulfilled
when:

| | |
|---|---|
| - | the relaxed measurement criterion in clause 5.2.4.9.3 is fulfilled for a period of |

T_{SearchDeltaP-Stationary},

| | |
|---|---|
| - | Srxlev> S_{SearchThresholdP2}, and, |
| - | Squal> S_{SearchThresholdQ2}, if S_{SearchThresholdQ2} is configured. |

Where:

| | |
|---|---|
| - | Srxlev = current Srxlev value of the serving cell (dB). |
| - | Squal = current Squal value of the serving cell (dB). |

For reference, the UE 1e-01 may measure the synchronization signal-based reference signal received power (S-RSRP) level and the synchronization signal-based reference signal received quality (SS-RSRQ) level of the serving cell at least once per M1*N1DRX cycle, and may evaluate a cell selection condition (S criterion) of the foregoing embodiment. The values of M1 and N1 may be determined by Table 9 below.

TABLE 9

| | | |
|---|---|---|
| DRX cycle | Scaling Factor (N1) | Nₛₑᵣᵥ[number of |

| length [s] | FR1 | FR2^{Note1} | DRX cycles] |
|---|---|---|---|
| 0.32 | 1 | 8 | M1*N1*4 |
| 0.64 | | 5 | M1*N1*4 |
| 1.28 | | 4 | N1*2 |
| 2.56 | | 3 | N1*2 |

^{Note1}Applies for UE supporting power class 2&3&4. For UE supporting power class 1, N1 = 8 for all DRX cycle length.

M1=2 if SMTC periodicity (TSMTC)>20 ms and DRX cycle≤0.64 second; Otherwise M1=1.

In operation 1e-35, the UE 1e-01 in the RRC idle mode or RRC inactive state may determine to reselect a cell satisfying the cell reselection criteria, based on the value of the measurement performed in operation 1e-30. Different criteria may be applied as the cell reselection criteria according to cell reselection priorities. When a plurality of cells having different cell reselection priorities satisfies the cell reselection criteria, reselecting a frequency/RAT cell with a higher cell reselection priority may take precedence over reselecting a frequency/RAT cell with a lower priority. Specifically, the operation of the UE 1e-01 according to criteria for reselecting an inter-frequency/inter-RAT cell having a higher priority than that of the frequency of the current serving cell may be as follows.

### First Operation

When SIB2 is broadcast including a threshold value of threshServingLowQ and one second has passed since the UE 1e-01 camping on the current serving cell, if the signal quality (Squal) of the inter-frequency/inter-RAT cell is greater than a threshold value of Thresh_{X,HighQ} for a specific time of Treselection_{RAT} (Squal>Thresh_{X,HighQ} during a time interval of Treselection_{RAT}), the UE 1e-01 reselect the inter-frequency/inter-RAT cell.

### Second Operation

The UE 1e-01 performs the second operation when failing to perform the first operation.
When one second has passed since the UE 1e-01 camping on the current serving cell and the reception level (Srxlev) of the inter-frequency/inter-RAT cell is greater than a threshold value of Thresh_{X,HighP} for a specific time of Treselection_{RAT} (Srxlev>Thresh_{X,HighP} during a time interval of Treselection_{RAT}), the UE 1e-01 reselects the inter-frequency/inter-RAT cell.

[001.63] Here, the UE 1e-01 may perform the first operation or the second operation, based on the information included in SIB4 broadcasted from the serving cell, such as the signal quality (Squal), the reception level (Srxlev), the threshold values (Threh_{X, HighQ} and Thresh_{X, HighP}), and Treselection_{RAT} of the inter-frequency cell, and may perform the first operation or the second operation, based on the information included in SIB5 broadcasted from the serving cell, such as the signal quality (Squal), reception level (Srxlev), the threshold values (Thresh_{X, HighQ} and Thresh_{X, HighP}), and Treselection_{RAT} of the inter-RAT cell. For example, SIB4 includes the value of Q_{qualmin} or the value of Qᵣₓₗₑᵥₘᵢₙ, and the UE 1e-01 may derive the signal quality (Squal) or reception level (Srxlev) of the inter-frequency cell, based on these values. When there is a plurality of cells on an NR frequency satisfying a high cell reselection priority, the UE 1e-01 may reselect a highest ranked cell among cells satisfying criteria for reselecting an intra-frequency/inter-frequency cell having the same priority as that of the frequency of the current serving cell to be described below.

In addition, the operation of the UE 1e-01 according to the criteria for reselecting the intra-frequency/inter-frequency cell having the same priority than that of the frequency of the current serving cell may be as follows.

### Third Operation

The UE may derive the rank of each cell, based on a measured value (RSRP) when the signal quality (Squal) and the reception level (Srxlev) of the intra-frequency/inter-frequency cell are greater than 0 (The UE shall perform ranking of all cells that fulfill the cell selection criterion S). The serving cell and a neighbor cell may be ranked by Equation 2.

$${R}_{s} = {Q}_{meas , s} + {Q}_{hyst -} {Qoffset}_{temp} \qquad Equation 2$$

$${R}_{n} = {Q}_{meas , n} - {Qoffset}_{-} {Qoffset}_{temp}$$

Q_{meas,s} is the measured RSRP value of the serving cell, Q_{meas,n} is the measured RSRP value of the neighbor cell, Q_{hyst} is the hysteresis value of the serving cell, and Qoffset is the offset between the serving cell and the neighbor cell. The value of Q_{hyst} is included in SIB2, and may be commonly used for reselecting the intra-frequency/inter-frequency cell. In a case of reselecting the intra-frequency cell, Qoffset may be signaled per cell, be applied only to an indicated cell, and be included in SIB3. In a case of reselecting the inter-frequency cell, Qoffset may be signaled per cell, be applied only to an indicated cell, and be included in SIB4. When the rank of the neighbor cell obtained by Equation 2 is greater than the rank of the serving cell (Rₙ>Rₛ), an optimal cell may be reselected from among the neighbor cells.
Qoffsetₜₑₘₚ is an offset temporarily applied to a cell, which may refer to connEstFailOffset included in ConnEstFailureControld broadcasted in SIB1, and may be applied when the RRC connection fails (e.g., when a T300 timer expires).

In addition, the operation of the UE 1e-01 according to criteria for reselecting an inter-frequency/inter-RAT cells having a lower priority than that of the frequency of the current serving cell may be as follows.

### Fourth Operation

When SIB2 is broadcast including the threshold value of threshServingLowQ and one second has passed since the UE 1e-01 camping on the current serving cell, if the signal quality (Sqaul) of the current serving cell is lower than a threshold value of Thresh_{Serving, LowQ} (Squa 1<Thresh_{Serving, LowQ}) and the signal quality (Squal) of the inter-frequency/inter-RAT cell is higher than a threshold value of Thresh_{X, LowQ} for a specific time of Treselection_{RAT} (Squal>ThreshX,LowQ during a time interval of Treselection_{RAT}), the UE 1e-01 may reselect the inter-frequency/inter-RAT cell.

### Fifth Operation

The UE 1e-01 performs the fifth operation when failing to perform the fourth operation.
When one second has passed since the UE 1e-01 camping on the current serving cell, the reception level (Srxlev) of the current serving cell is lower than a threshold value of Thresh_{Serving, LowP} (Srxlev<Thresh_{Serving, LowP}), and the reception level (Srxlev) of the inter-frequency/inter-RAT cell is higher than the threshold value Thresh_{X, LowQ} for a specific time interval of Treselection_{RAT} (Srxlev>ThreshX,LowP during a time interval of Treselection_{RAT}), the UE 1e-01 may reselect to the inter-frequency/inter-RAT cell.

Here, the UE 1e-01 may perform the fourth or fifth operation for the inter-frequency cell, based on the threshold values (Thresh_{Serving, LowQ} and Thresh_{Serving, LowP}) included in SIB2 broadcasted from the serving cell and the signal quality (Squal), the reception level (Srxlev), the threshold values (Threh_{X, LowQ} and Thresh_{X, LowP}), and Treselection_{RAT} of the inter-frequency cell included in SIB4 broadcasted from the serving cell, and may perform the fourth or fifth operation for the inter-RAT cell, based on the threshold values (Thresh_{Serving, LowQ} and Thresh_{Serving, LowP}) included in SIB2 broadcasted from the serving cell and the signal quality (Squal), the reception level (Srxlev), the threshold values (Thresh_{X, LowQ} and Thresh_{X, LowP}), and Treselection_{RAT} of the inter-RAT cell included in SIB5 broadcasted from the serving cell. For example, SIB4 includes the value of Q_{qualmin} or the value of Qᵣₓₗₑᵥₘᵢₙ, and the UE 1e-01 may derive the signal quality (Squal) or reception level (Srxlev) of the inter-frequency cell based on these values. When there is a plurality of cells on an NR frequency satisfying a high cell reselection priority, the UE 1e-01 may reselect the highest ranked cell among the cells satisfying criteria for reselecting the intra-frequency/inter-frequency cell having the same priority as that of the frequency of the current serving cell to be described below.

In operation 1e-40, the UE 1e-01 in the RRC idle mode or RRC inactive state may receive system information (e.g., an MIB or SIB1) broadcasted by a candidate target cell before finally reselecting the candidate target cell, and may determine, based on the received system information, whether the reception level (Srxlev) and the reception quality (Squal) of the candidate target cell satisfy a cell selection criterion (Srxlev>0 and Squal>0) called an S-criterion Equation 1. When Equation 1 is satisfied and the candidate target cell is suitable, the UE 1e-01 may reselect the candidate target cell.

FIG. 1F illustrates a UE supporting a low-power wake-up receiver replaces a serving cell measurement result of a main radio with a serving cell measurement result derived through the low-power wake-up receiver and performs frequency measurement for cell reselection in a next-generation mobile communication system according to an embodiment of the disclosure.

Referring to FIG. 1F, a UE 1f-01 according to an embodiment of the disclosure may include a main radio (hereinafter “MR”) 1f-02 and a low-power wake-up receiver (LP-WUR, hereinafter referred to as “LR”) 1f-03 to perform a predetermined operation. The MR 1f-02 included in the UE 1f-01 may refer to a transceiver (Tx/Rx) module operating for NR signals/channels apart from signals/channels related to low-power wake-up, and the LR 1f-03 additionally included in the UE 1f-01 may refer to a receiver (Rx) module operating for receiving/processing signals/channels related to low-power wake-up. Since less power is consumed when using the LR 1f-03 than when using the MR 1f-02, the UE 1f-01 may turn off the MR 1f-02 and use the LR 1f-03 or may allow the LR 1f-03 to perform measurement instead of the MR 1f-02 according to a predetermined condition, thereby saving power. To save power, the UE 1f-01 may determine whether to turn on or off the MR 1f-02 or to perform measurement through the MR 1f-02, based on a signal related to low-power wake-up received through the LR 1f-03. For reference, a state in which the MR 1f-02 of the UE 1f-01 sleeps/is turned off may be referred to as an ultra-deep-sleep state. For reference, the UE 1f-01 deriving a serving cell measurement result may mean that the UE 1f-01 performs serving cell measurement.

The UE 1f-01 may establish an RRC connection with an NR base station 1f-05 to be in an RRC connected mode (RRC_CONNECTED) (operation 1f-06).

In operation 1f-07, the UE 1f-01 may transmit a UE capability information message (UECapabilityInformation) to the base station 1f-05. According to an embodiment of the disclosure, the UE 1f-01 may transmit the UE capability information message at a request of the base station 1f-05. The message may include at least one of the following.
Indicator indicating whether the UE 1f-01 supports the LR 1f-03
Indicator indicating whether the UE 1f-01 is capable of performing relaxed measurement on a serving cell and/or neighbor cells according to support of the LR 1f-03
Indicator indicating whether the UE 1f-01 is capable of replacing a serving cell measurement of the MR 1f-02 with a serving cell measurement derived through the LR 1f-03 (i.e., offloading serving cell measurement from MR to LR)

In operation 1f-08, the NR base station 1f-05 may transmit an RRC connection release message (RRCRelease) to the UE 1f-01. The message may include at least one of the following.
Indicator indicating whether the UE 1f-01 may perform relaxed measurement on the serving cell through the MR 1f-02 when a serving cell measurement result derived through the LR 1f-03 of the UE 1f-01 satisfies a predetermined condition
Indicator indicating whether the UE 1f-01 may perform relaxed measurement on a neighbor cell through the MR 1f-02 when a serving cell measurement result derived through the LR 1f-03 of the UE 1f-01 satisfies a predetermined condition (specific details about the relaxed measurement may follow operation 1f-35 to be described below)
Indicator indicating whether a serving cell measurement result derived through the LR 1f-03 of the UE 1f-01 may replace a serving cell measurement result of the MR 1f-02 of the UE 1f-01 (offloading of serving cell measurement from MR to LR)
Timer value indicating time when a serving cell measurement result derived through the LR 1f-03 of the UE 1f-01 may replace a serving cell measurement result of the MR 1f-02 of the UE 1f-01 (offloading of serving cell measurement from MR to LR) or a time period with start and end points for replacement
When the timer value is configured, the UE 1f-01 may operate a timer, and may replace the serving cell measurement result of the MR 1f-02 of the UE 1f-01 with the serving cell measurement result derived through the LR 1f-03 of the UE 1f-01 (offloading of serving cell measurement from MR to LR) while the timer is operating.
When the time period is configured, the UE 1f-01 may replace the serving cell measurement result of the MR 1f-02 of the UE 1f-01 with the serving cell measurement result derived through the LR 1f-03 of the UE 1f-01 (offloading of serving cell measurement from MR to LR) during the configure time period.
Parameter for deriving a serving cell measurement result through the LR 1f-03 of the UE 1f-01 on a shorter measurement cycle than that in the foregoing embodiment (FIG. 1E) when offloading serving cell measurement from the MR to the LR
The parameter may refer to K2 (an integer value equal to or greater than 1), and the LR 1f-03 of the UE 1f-01 may measure the SS_{LR}-RSRP level and/or the SS_{LR}-RSRQ level of the serving cell every K2*M1*N1DRX cycle.
Offset parameters required to derive a serving cell measurement result through the LR 1f-03 of the UE 1f-01 and to replace a serving cell measurement result of the MR 1f-02 with the same when offloading serving cell measurement from the MR to the LR
The parameters may be used when replacing the SS-RSRP level by adding an offset value to the SS_{LR}-RSRP level, based on which the values of Srxlev and Squal may be derived.
The parameters may be used when replacing the SS-RSRQ level by adding an offset value to the SS_{LR}-RSRQ level, based on which the values of Srxlev and Squal may be derived.
Threshold value(s) and/or time period required to derive a serving cell measurement result through the LR 1f-03 of the UE 1f-01 and to determine whether to replace a serving cell measurement result of the MR 1f-02 with the same when offloading serving cell measurement from the MR to the LR
When threshold 1 and threshold 2 are configured, if threshold 1<Srxlev-Srxlev_{LP}<threshold 2 is satisfied, the serving cell measurement result derived through the LR 1f-03 of the UE 1f-01 may replace the serving cell measurement result of MR 1f-02.
The time period may be configured together, in which case if threshold 1<Srxlev-Srxlev_{LP}<threshold 2 is satisfied during the time period, the serving cell measurement result derived through the LR 1f-03 of the UE 1f-01 may replace the serving cell measurement result of the MR 1f-02.
When a threshold is configured, if threshold<Srxlev-Srxlev_{LP}, S-rxlev-Srxlev_{LP}<Threshold, or Srxlev_{LP}>threshold is satisfied, the serving cell measurement result derived through the LR 1f-03 of the UE 1f-01 may replace the serving cell measurement result of the MR 1f-02.
   The time period may be configured together, in which case if threshold<Srxlev-Srxlev_{LP} or S-rxlev-Srxlev_{LP}<Threshold, or Srxlev_{LP}>threshold is satisfied during the time period, the serving cell measurement result derived through the LR 1f-03 of the UE 1f-01 may replace the serving cell measurement result of the MR 1f-02.

In operation 1f-10, the UE 1f-01 may transition to an RRC idle mode (RRC_IDLE) or RRC inactive mode (RRC_INACTIVE), which may follow the foregoing embodiment described with reference to FIG. 1E.

In operation 1f-15, the UE 1f-01 may receive essential system information broadcast by the NR cell 1f-05 through the MR 1f-02. In the disclosure, a master information block (MIB) and system information block 1 (SIB1) may be referred to as the essential system information. The essential system information (MIB or SIB1) may include predetermined information applicable to the UE 1f-01 supporting the LR 1f-03. The predetermined information may refer to at least one of the following.
Indicator indicating whether a low-power synchronization signal (LP-SS) is transmitted or configuration information about the LP-SS
Indicator indicating whether a low-power wake-up signal (LP-WUS) is transmitted or configuration information about the LP-WUS
Indicator indicating whether a serving cell measurement result derived through the LR 1f-03 of the UE 1f-01 may replace a serving cell measurement result of the MR 1f-02 of the UE 1f-01 (offloading of serving cell measurement from MR to LR)
Parameter for deriving a serving cell measurement result through the LR 1f-03 of the UE 1f-01 on a shorter measurement cycle than in the foregoing embodiment (FIG. 1E) when offloading serving cell measurement from the MR to the LR
The parameter may refer to K2 (an integer value equal to or greater than 1), and the LR 1f-03 of the UE 1f-01 may measure the SS_{LR}-RSRP level and/or the SS_{LR}-RSRQ level of the serving cell every K2*M1*N1DRX cycle.
Time period with start and end points in which a serving cell measurement result derived through the LR 1f-03 of the UE 1f-01 replaces a serving cell measurement result of the MR 1f-02 of the UE 1f-01 (offloading of serving cell measurement from MR to LR)
Offset parameters required to derive a serving cell measurement result through the LR 1f-03 of the UE 1f-01 and to replace a serving cell measurement result of the MR 1f-02 with the same when offloading serving cell measurement from the MR to the LR
The parameters may be used when replacing the SS-RSRP level by adding an offset value to the SS_{LR}-RSRP level, based on which the values of Srxlev and Squal may be derived.
The parameters may be used when replacing the SS-RSRQ level by adding an offset value to the SS_{LR}-RSRQ level, based on which the values of Srxlev and Squal may be derived.
Threshold value(s) and/or time period required to derive a serving cell measurement result through the LR 1f-03 of the UE 1f-01 and to determine whether to replace a serving cell measurement result of the MR 1f-02 with the same when offloading serving cell measurement from the MR to the LR
When threshold 1 and threshold 2 are configured, if threshold 1<Srxlev-Srxlev_{LP}<threshold 2 is satisfied, the serving cell measurement result derived through the LR 1f-03 of the UE 1f-01 may replace the serving cell measurement result of MR 1f-02.
The time period may be configured together, in which case if threshold 1<Srxlev-Srxlev_{LP}<threshold 2 is satisfied during the time period, the serving cell measurement result derived through the LR 1f-03 of the UE 1f-01 may replace the serving cell measurement result of the MR 1f-02.
When a threshold is configured, if threshold<Srxlev-Srxlev_{LP}, S-rxlev-Srxlev_{LP}<Threshold, or Srxlev_{LP}>threshold is satisfied, the serving cell measurement result derived through the LR 1f-03 of the UE 1f-01 may replace the serving cell measurement result of the MR 1f-02.
The time period may be configured together, in which case if threshold<Srxlev-SrxlevLPor S-rxlev-Srxlev_{LP}<Threshold, or Srxlev_{LP}>threshold is satisfied during the time period, the serving cell measurement result derived through the LR 1f-03 of the UE 1f-01 may replace the serving cell measurement result of the MR 1f-02.

In operation 1f-20, the UE 1f-01 may perform a cell selection procedure, based on the essential system information received in operation 1f-15, which may follow the foregoing embodiment. For reference, the UE 1f-01 may perform the cell selection procedure through the MR 1f-02.

In operation 1f-25, the UE 1f-01 may obtain system information (e.g., SIB2, SIB3, SIB4, SIB5, and a new SIB) including cell reselection information from the serving cell 1f-05 to perform a cell reselection evaluation process, which may follow the foregoing embodiment. In addition, in the disclosure, predetermined information applicable when the UE 1f-01 supporting the LR 1f-03 performs the cell reselection evaluation process may be broadcast in the system information. The predetermined information may refer to at least one of the following.
Threshold value of a specific measurement metric or threshold value of each measurement metric
When the measurement metric is about an LP-SS, the measurement metric may refer to at least one of an LP-received signal strength indicator (RSSI), an LP-received signal received power (RSRP), an LP-received signal received quality (RSRQ), and an LP-signal to interference plus noise ratio (SINR).
When the measurement metric is about an LP-WUS, the measurement metric may refer to at least one of an LP-WUS RSSI, an LP-WUS RSRP, an LP-WUS RSRQ, and an LP-WUS SINR.
Time period T_{LP} or number of times NLP for satisfying a measurement metric condition
Q_{rxlevminLP}: Minimum signal reception level value in the LP coverage of a cell where the UE 1f-01 supporting the LR 1f-03 supports an LP-WUS and/or an LP-SS
Q_{qualminLP}: Minimum signal quality level value in the LP coverage of a cell where the UE 1f-01 supporting the LR 1f-03 supports an LP-WUS and/or an LP-SS
Q_{rxlevminoffsetLP}: Minimum signal reception level offset value in the LP coverage of a cell where the UE 1f-01 supporting the LR 1f-03 supports an LP-WUS and/or an LP-SS
Q_{qualminoffsetLP}: Minimum signal quality level offset value in the LP coverage of a cell where the UE 1f-01 supporting the LR 1f-03 supports an LP-WUS and/or an LP-SS
Threshold value of Srxlev_{LP} and/or threshold value of Squal_{LP}
Period value (T_{S, LP}) for which a specific condition for the LR 1f-03 needs to be satisfied
Threshold value (S_{delta, LP}) that must satisfy a specific condition for LR 1f-03
Indicator indicating whether the UE 1f-01 may perform relaxed measurement on the serving cell through the MR 1f-02 when a serving cell measurement result derived through the LR 1f-03 of the UE 1f-01 satisfies a predetermined condition
Indicator indicating whether the UE 1f-01 may perform relaxed measurement on a neighbor cell through the MR 1f-02 when a serving cell measurement result derived through the LR 1f-03 of the UE 1f-01 satisfies a predetermined condition
Indicator indicating whether a serving cell measurement result derived through the LR 1f-03 of the UE 1f-01 may replace a serving cell measurement result of the MR 1f-02 of the UE 1f-01 (offloading of serving cell measurement from MR to LR)
Parameter for deriving a serving cell measurement result through the LR 1f-03 of the UE 1f-01 on a shorter measurement cycle than that in the foregoing embodiment (FIG. 1E) when offloading serving cell measurement from the MR to the LR
The parameter may refer to K2 (an integer value equal to or greater than 1), and the LR 1f-03 of the UE 1f-01 may measure the SS_{LR}-RSRP level and/or the SS_{LR}-RSRQ level of the serving cell every K2*M1*N1DRX cycle.
Indicator indicating whether a serving cell measurement result derived through the LR 1f-03 of the UE 1f-01 may replace a serving cell measurement result of the MR 1f-02 of the UE 1f-01 (offloading of serving cell measurement from MR to LR)
Time period with start and end points in which a serving cell measurement result derived through the LR 1f-03 of the UE 1f-01 replaces a serving cell measurement result of the MR 1f-02 of the UE 1f-01 (offloading of serving cell measurement from MR to LR)
Offset parameters required to derive a serving cell measurement result through the LR 1f-03 of the UE 1f-01 and to replace a serving cell measurement result of the MR 1f-02 with the same when offloading serving cell measurement from the MR to the LR
The parameters may be used when replacing the SS-RSRP level by adding an offset value to the SS_{LR}-RSRP level, based on which the values of Srxlev and Squal may be derived.
The parameters may be used when replacing the SS-RSRQ level by adding an offset value to the SS_{LR}-RSRQ level, based on which the values of Srxlev and Squal may be derived.
Threshold value(s) and/or time period required to derive a serving cell measurement result through the LR 1f-03 of the UE 1f-01 and to determine whether to replace a serving cell measurement result of the MR 1f-02 with the same when offloading serving cell measurement from the MR to the LR
When threshold 1 and threshold 2 are configured, if threshold 1<Srxlev-Srxlev_{LP}<threshold 2 is satisfied, the serving cell measurement result derived through the LR 1f-03 of the UE 1f-01 may replace the serving cell measurement result of MR 1f-02.
   The time period may be configured together, in which case if threshold 1<Srxlev-Srxlev_{LP}<threshold 2 is satisfied during the time period, the serving cell measurement result derived through the LR 1f-03 of the UE 1f-01 may replace the serving cell measurement result of the MR 1f-02.
When a threshold is configured, if threshold<Srxlev-Srxlev_{LP}, S-rxlev-Srxlev_{LP}<Threshold, or Srxlev_{LP}>threshold is satisfied, the serving cell measurement result derived through the LR 1f-03 of the UE 1f-01 may replace the serving cell measurement result of the MR 1f-02.
The time period may be configured together, in which case if threshold<Srxlev-Srxlev_{LP} or S-rxlev-Srxlev_{LP}<Threshold, or Srxlev_{LP}>threshold is satisfied during the time period, the serving cell measurement result derived through the LR 1f-03 of the UE 1f-01 may replace the serving cell measurement result of the MR 1f-02.

The UE 1f-01 may perform the cell reselection evaluation process. The cell reselection evaluation process may refer to a series of processes for reselecting a cell by performing reselection priorities handling, performing frequency measurement by applying measurement rules for cell reselection, and evaluating cell reselection criteria.

In operation 1f-30, the UE 1f-01 may determine a cell reselection priority according to the foregoing embodiment.

In operation 1f-35, the UE 1f-01 may perform frequency measurement for cell reselection. The UE 1f-01 according to the disclosure may replace a serving cell measurement result of the MR 1f-02 with a serving cell measurement result derived through the LR 1f-03 (the cycle of serving cell measurement through the LR 1f-03 is the same as that of serving cell measurement performed through the MR 1f-02 according to the foregoing embodiment) when at least one of the following conditions is satisfied.
Condition 1: When the indicator indicating whether the serving cell measurement result derived through the LR 1f-03 of the UE 1f-01 may replace the serving cell measurement result of the MR 1f-02 of the UE 1f-01 (offloading of serving cell measurement from MR to LR) is provided in operation 1f-08 and/or operation 1f-15 and/or operation 1f-25
Condition 2: When the timer value indicating the time when the serving cell measurement result derived through the LR 1f-03 of the UE 1f-01 replaces the serving cell measurement result of the MR 1f-02 of the UE 1f-01 (offloading of serving cell measurement from MR to LR) or the time period with the start and end points for the replacement is provided in operation 1f-08 and/or operation 1f-15 and/or operation 1f-25. For reference, when the timer value is provided, the UE 1f-01 may replace the serving cell measurement result derived through the LR 1f-03 replaces the serving cell measurement result of the MR 1f-02 only when the timer operates.
Condition 3: When the offset parameters required to replace the serving cell measurement result of the MR 1f-02 with the serving cell measurement result through the LR 1f-03 of the UE 1f-01 are provided in operation 1f-08 and/or operation 1f-15 and/or operation 1f-25
Condition 4: When the threshold value(s) and/or the time period required to replace the serving cell measurement result of the MR 1f-02 with the serving cell measurement result through the LR 1f-03 of the UE 1f-01 are provided in operation 1f-08 and/or operation 1f-15 and/or operation 1f-25
When threshold 1 and threshold 2 are configured, if threshold 1<Srxlev-Srxlev_{LP}<threshold 2 is satisfied, the serving cell measurement result derived through the LR 1f-03 of the UE 1f-01 may replace the serving cell measurement result of MR 1f-02.
   The time period may be configured together, in which case if threshold 1<Srxlev-Srxlev_{LP}<threshold 2 is satisfied during the time period, the serving cell measurement result derived through the LR 1f-03 of the UE 1f-01 may replace the serving cell measurement result of the MR 1f-02.
When a threshold is configured, if threshold<Srxlev-Srxlev_{LP}, S-rxlev-Srxlev_{LP}<Threshold, or Srxlev_{LP}>threshold is satisfied, the serving cell measurement result derived through the LR 1f-03 of the UE 1f-01 may replace the serving cell measurement result of the MR 1f-02.
   The time period may be configured together, in which case if threshold<Srxlev-Srxlev_{LP} or S-rxlev-Srxlev_{LP}<Threshold, or Srxlev_{LP}>threshold is satisfied during the time period, the serving cell measurement result derived through the LR 1f-03 of the UE 1f-01 may replace the serving cell measurement result of the MR 1f-02.

The UE 1f-01 according to the disclosure may replace a serving cell measurement result of the MR 1f-02 with a serving cell measurement result derived through the LR 1f-03 (the cycle of serving cell measurement through the LR 1f-03 is shorter than that of serving cell measurement performed through the MR 1f-02 according to the foregoing embodiment of the disclosure, for example, a serving cell measurement cycle of K2*MR (K2<=1)) when at least one of the following conditions is satisfied.
Condition 1: When the indicator indicating whether the serving cell measurement result derived through the LR 1f-03 of the UE 1f-01 may replace the serving cell measurement result of the MR 1f-02 of the UE 1f-01 (offloading of serving cell measurement from MR to LR) is provided in operation 1f-08 and/or operation 1f-15 and/or operation 1f-25
Condition 2: When the timer value indicating the time when the serving cell measurement result derived through the LR 1f-03 of the UE 1f-01 replaces the serving cell measurement result of the MR 1f-02 of the UE 1f-01 (offloading of serving cell measurement from MR to LR) or the time period with the start and end points for the replacement is provided in operation 1f-08 and/or operation 1f-15 and/or operation 1f-25. For reference, when the timer value is provided, the UE 1f-01 may replace the serving cell measurement result derived through the LR 1f-03 replaces the serving cell measurement result of the MR 1f-02 only when the timer operates.
Condition 3: When the parameter (K2) for deriving the serving cell measurement result through the LR 1f-03 of the UE 1f-01 on a shorter measurement cycle than that in the foregoing embodiment (FIG. 1E) is provided in operation 1f-08 and/or operation 1f-15 and/or operation 1f-25
Condition 4: When the offset parameters required to derive the serving cell measurement result through the LR 1f-03 of the UE 1f-01 and to replace the serving cell measurement result of the MR 1f-02 with the same are provided in operation 1f-08 and/or operation 1f-15 and/or operation 1f-25
Condition 5: When the threshold value(s) and/or the time period required to replace the serving cell measurement result of the MR 1f-02 with the serving cell measurement result through the LR 1f-03 of the UE 1f-01 are provided in operation 1f-08 and/or operation 1f-15 and/or operation 1f-25
When threshold 1 and threshold 2 are configured, if threshold 1<Srxlev-Srxlev_{LP}<threshold 2 is satisfied, the serving cell measurement result derived through the LR 1f-03 of the UE 1f-01 may replace the serving cell measurement result of MR 1f-02.
   The time period may be configured together, in which case if threshold 1<Srxlev-Srxlev_{LP}<threshold 2 is satisfied during the time period, the serving cell measurement result derived through the LR 1f-03 of the UE 1f-01 may replace the serving cell measurement result of the MR 1f-02.
When a threshold is configured, if threshold<Srxlev-Srxlev_{LP}, S-rxlev-Srxlev_{LP}<Threshold, or Srxlev_{LP}>threshold is satisfied, the serving cell measurement result derived through the LR 1f-03 of the UE 1f-01 may replace the serving cell measurement result of the MR 1f-02.
   The time period may be configured together, in which case if threshold<Srxlev-Srxlev_{LP} or S-rxlev-Srxlev_{LP}<Threshold, or Srxlev_{LP}>threshold is satisfied during the time period, the serving cell measurement result derived through the LR 1f-03 of the UE 1f-01 may replace the serving cell measurement result of the MR 1f-02.

In addition, the UE 1f-01 according to the disclosure may measure the SS-RSRP level and the SS-RSRQ level of the serving cell through the MR 1f-02 according to a measurement cycle longer than the measurement cycle (i.e., at least M1*N1DRX cycle) in the foregoing embodiment of FIG. 1E, or may not measure the SS-RSRP level and the SS-RSRQ level of the serving cell through the MR 1f-02. The foregoing operation of the UE 1f-01 may be performed when at least one of the following proposed conditions (i.e., the following conditions may be determined in combination, or only one of the conditions may be determined) is satisfied.
Condition 1: When a serving cell measurement result measured by the UE 1f-01 through the MR 1f-02 satisfies Srxlev>SIntraSearchP and Squal>SIntraSearchQ or when Srxlev>S_{SearchThresholdP} and Squal>S_{SearchThresholdQ} is satisfied if S_{Search ThresholdQ} is configured
Condition 2: When a serving cell measurement result measured by the UE 1f-01 through the LR 1f-03 satisfies at least one of the following specific metrics
LP-RSSI>Common threshold value or threshold value of LP-RSSI and/or
LP-RSRP>Common threshold value or threshold value of LP-RSRP and/or
LP-RSRQ>Common threshold value or threshold value of LP-RSRQ and/or
LP-SINR>Common threshold value or threshold value of LP-SINR
Condition 3: When a serving cell measurement result measured by the UE 1f-01 through the LR 1f-03 satisfies condition 2 in T_{LP}, or consecutively satisfies condition 2 in NLP
Condition 4: When a serving cell measurement result measured by the UE 1f-01 through the LR 1f-03 satisfies Srxlev_{LP}>0 or Srxlev_{LP}>threshold value of Srxlev_{LP}
where

$${Srxlev}_{LP} = {Q}_{rxlevmeasLP} - ( {Q}_{rxlev minLP} + {Q}_{rxlevminoffsetLP} ) - {P}_{compensation} - {Qoffset}_{temp}$$

Q_{rxlevmeasLP} is a value measured for the received signal level of the LP-SS and/or LP-WUS of the serving cell measured by the UE 1f-01 through LR 1f-03
At least one of Q_{rxlevminoffsetLP}, P_{compensation}, and Q_{offsettemp} may not be applicable to the UE 1f-01, in which case the UE 1f-01 may consider the value as 0 (i.e., the parameter may not be considered in Srxlev_{LP}).
Condition 5: When a serving cell measurement result measured by the UE 1f-01 through the LR 1f-03 satisfies Squal_{LP}>0 or Squal_{LP}>threshold value of Squal_{LP}
where

$${Squal}_{LP} = {Q}_{qualmeasLP} - ( {Q}_{qualminLP} + {Q}_{qualminoffsetLP} ) - {Qoffset}_{temp}$$

Q_{qualmeasLP} is the reception quality value of an LP-SS and/or LP-WUS of the serving cell measured by the UE through the LR 1f-03
At least one of Q_{qualminoffsetLP} and Q_{offsettemp} may not be applied to the UE 1f-01, in which case the UE 1f-01 may consider the value as 0 (i.e., the parameter may not be considered in Squal_{LP}).
Condition 8: When at least one of conditions 4 and condition 5 is satisfied in T_{S, LP}
Condition 9: When the measurement metrics used in condition 2 satisfy the following condition in T_{LP}
Serving cell measurement metric_{ref}-serving cell measurement metric value<measurement metric threshold value
where
Serving cell measurement metric=Current measurement metric value of the serving cell measured by the UE through the LR 1f-03
Serving cell measurement metric_{ref}=Reference measurement metric value for the serving cell
When a new cell is selected or reselected, when serving cell measurement metric value-serving cell measurement metric ref>0, or when condition 9 is not satisfied in T_{LP}, the UE 1f-01 may configure the serving cell measurement metric to the serving cell measurement metric_{ref}.
Condition 10: When Srxlev_{LP} used in condition 4 satisfies the following condition in T_{S, LP}

$${Srxlev}_{LP , Ref} - {Srxlev}_{LP} < {S}_{delta , LP}$$

where
Srxlev_{LP}=Current measurement value of the serving cell measured by the UE 1f-01 through the LR 1f-03
Srxlev_{LP,Ref}=Reference measurement value for the serving cell
When a new cell is selected or reselected, when Srxlev_{LP}-Srxlev_{LP, Ref}>0, or when condition 10 is not satisfied in T_{S, LP}, the UE 1f-01 may configure the current serving cell measurement value measured through the LR 1f-03 to the reference measurement value for the serving cell.
Condition 11: When an indicator indicating that the UE 1f-01 measures the SS-RSRP level and SS-RSRQ level of the serving cell through the MR 1f-02 on a cycle longer than the measurement cycle (i.e., at least M1*N1DRX cycle) of the foregoing embodiment of FIG. 1E or does not measure the SS-RSRP level and SS-RSRQ level of the serving cell through the MR 1f-02 is broadcast in the system information or configured through the RRC connection release message when a serving cell measurement result derived through the LR 1f-03 of the UE 1f-01 satisfies at least one of the foregoing conditions.

For reference, the UE 1f-01 may turn off the MR 1f-02 to save power in a period when the UE 1f-01 does not need to measure the SS-RSRP level and SS-RSRQ level of the serving cell through the MR 1f-02. However, the foregoing conditions are not satisfied, the UE 1f-01 may turn on the MR 1f-02 to measure the SS-RSRP level and SS-RSRQ level of the serving cell according to the foregoing embodiment. In addition, the UE 1f-01 according to the disclosure may not measure a neighbor cell through the MR 1f-02, may perform relaxed measurement specified in Table 8 of the foregoing embodiment (FIG. 1E) (i.e., at least one of 4.2.2.9, 4.2.2.10, 4.2.2.11, 4.2C.2.7, 4.2C.2.8, 4.2B.2.9, 4.2B.2.10, and 4.2B.2.11 specified in TS 38.133), or may measure a neighbor cell on a longer cycle in a period in which when the UE 1f-01 does not need to measure the SS-RSRP level and SS-RSRQ level of the serving cell through the MR 1f-02. The foregoing neighbor cell measurement may be performed when an indicator indicating whether the UE 1f-01 may relax the measurement on the neighbor cell through the MR 1f-02 is broadcast in the system information or configured in the RRC connection release message. For reference, the UE 1f-01 may not measure the serving cell through the MR 1f-02 when having measured the serving cell through the MR 1f-02, may not measure the neighbor cell through the MR 1f-02 when having measured the neighbor cell through the MR 1f-02, or may not perform measurement through the MR 1f-02 when having performed measurement through the MR 1f-02.

In operation 1f-40, the UE 1f-01 may determine to reselect a cell satisfying the cell reselection criteria, based on the value of the measurement performed in operation 1f-35, which may follow the foregoing embodiment.

In operation 1f-45, the UE 1f-01 may receive system information (e.g., an MIB or SIB1) broadcasted by a candidate target cell before finally reselecting the candidate target cell, and may determine, based on the received system information, whether both the cell selection reception signal level (Srxlev) and the cell selection signal quality (Squal) of the candidate target cell are greater than 0 (i.e., satisfy a cell selection criterion (Srxlev>0 and Squal>0)). When the cell selection criterion is satisfied and the candidate target cell is suitable, the UE 1f-01 may reselect the candidate target cell.

FIG. 1G illustrates a UE supporting a low-power wake-up receiver replaces a serving cell measurement result of a main radio with a serving cell measurement result derived through the low-power wake-up receiver or derives a serving cell measurement result of the main radio on a longer cycle in a next-generation mobile communication system according to an embodiment of the disclosure.

Referring to FIG. 1G, a UE 1g-01 according to an embodiment of the disclosure may include a main radio (hereinafter “MR”) 1g-02 and a low-power wake-up receiver (hereinafter “LR”) 1g-03 to perform a predetermined operation. The MR 1g-02 included in the UE 1g-01 may refer to a transceiver (Tx/Rx) module operating for NR signals/channels apart from signals/channels related to low-power wake-up, and the LR 1g-03 additionally included in the UE 1g-01 may refer to a receiver (Rx) module operating for receiving/processing signals/channels related to low-power wake-up. Since less power is consumed when using the LR 1g-03 than when using the MR 1g-02, the UE 1g-01 may turn off the MR 1g-02 and use the LR 1g-03 or may allow the LR 1g-03 to perform measurement instead of the MR 1g-02 according to a predetermined condition, thereby saving power. To save power, the UE 1g-01 may determine whether to turn on or off the MR 1g-02 or to perform measurement through the MR 1g-02, based on a signal related to low-power wake-up received through the LR 1g-03. For reference, a state in which the MR 1g-02 of the UE 1g-01 is turned off may be referred to as an ultra-deep-sleep state. For reference, the UE 1g-01 deriving a serving cell measurement result may mean that the UE 1g-01 performs serving cell measurement.

The UE 1g-01 may establish an RRC connection with an NR base station 1g-05 to be in an RRC connected mode (RRC_CONNECTED) (operation 1g-06).

In operation 1g-07, the UE 1g-01 may transmit a UE capability information message (UECapabilityInformation) to the base station 1g-05. According to an embodiment of the disclosure, the UE 1g-01 may transmit the UE capability information message at a request of the base station 1g-05, which may follow the foregoing embodiment described with reference to FIG. 1F.

In operation 1g-08, the NR base station 1g-05 may transmit an RRC connection release message (RRCRelease) to the UE 1g-01, which may follow the foregoing embodiment. The message may include at least one of the following.
Indicator indicating whether a serving cell measurement result is not derived through the MR 1g-02 or a serving cell measurement result may be derived on a longer cycle than in the foregoing embodiment (FIG. 1E) when a serving cell measurement result derived through the LR 1g-03 of the UE 1g-01 replaces a serving cell measurement result of the MR 1g-02 of the UE 1g-01 (offloading of serving cell measurement from MR to LR) according to the foregoing embodiment (FIG. 1F)
Indicator indicating whether a serving cell measurement result is not derived through the MR 1g-02 of the UE 1g-01 or a serving cell measurement result may be derived on a longer cycle than in the foregoing embodiment (FIG. 1E)
When the serving cell measurement result derived through the MR 1g-02 of the UE 1g-01 satisfies a predetermined condition, the UE 1g-01 may not derive the serving cell measurement result through the MR 1g-02, or may derive the serving cell measurement result on the longer period than in the foregoing embodiment (FIG. 1E). The predetermined condition may refer to at least one of the following.
   Condition 1: Srxlev_{LP} (Srxlev_{MP})>S_{servingP} (or Srxlev_{LP} (Srxlev_{MP})≥S_{servingP}) and/or Squal_{LP} (Squal_{MP})>S_{servingQ} (or Squal_{LP} (Squal_{MP})>S_{servingQ}) where S_{servingP} and/or S_{servingQ} are broadcasted
   Condition 2: Srxlev_{LP} (Srxlev_{MP})>S_{servingP} (or Srxlev_{LP} (Srxlev_{MP})≥S_{servingP}) for T_{serving} (time duration) and/or Squal_{LP} (Squal_{MP})>S_{servingQ} (or Squal_{LP} (Squal_{MP})>S_{servingQ}) T_{serving} (time duration) where S_{servingP} and/or S_{servingQ} and/or T_{serving} are broadcasted
Indicator indicating whether a timer indicating a period in which a serving cell measurement result is not derived through the MR 1g-02 of the UE 1g-01 or a serving cell measurement result is derived on a longer cycle than in the foregoing embodiment (FIG. 1E) may be operated
When the value of the timer is configured, the UE 1g-01 may operate the timer, and when a serving cell measurement result derived through the LR 1g-03 of the UE 1g-01 replaces the serving cell measurement result of the MR 1g-02 of the UE 1g-01 (offloading of serving cell measurement from MR to LR) according to the foregoing embodiment (FIG. 1F) while the timer is operating, the UE 1g-01 may not derive the serving cell measurement result through the MR 1g-02, or may derive the serving cell measurement result on the longer period than in the foregoing embodiment (FIG. 1E).
When the time period is configured, if the serving cell measurement result derived through the MR 1g-02 satisfies condition 1 and/or condition 2 described above, the UE 1g-01 may not derive the serving cell measurement result through the MR 1g-02 of the UE 1g-01, or may derive the serving cell measurement result on the longer cycle than in the foregoing embodiment (FIG. 1E).

In operation 1g-10, the UE 1g-01 may transition to an RRC idle mode (RRC_IDLE) or RRC inactive mode (RRC_INACTIVE), which may follow the foregoing embodiment.

In operation 1g-15, the UE 1g-01 may receive essential system information broadcast by the NR cell 1g-05 through the MR 1g-02. In the disclosure, a master information block (MIB) and system information block 1 (SIB1) may be referred to as the essential system information, which may follow at least one of the foregoing embodiments. In addition, the essential system information may include at least one of the following.
Indicator indicating that a serving cell measurement result does not need to be derived through the MR 1g-02, indicator indicating whether a serving cell measurement result may be derived through the MR 1g-02 on a longer cycle than in the foregoing embodiment (FIG. 1E), or parameter (e.g., K3) for indicating a longer cycle when a serving cell measurement result derived through the LR 1g-03 of the UE 1g-01 replaces the serving cell measurement result of the MR 1g-02 of the UE 1g-01 (offloading of serving cell measurement from MR to LR) according to the foregoing embodiment (FIG. 1F)
In a case of the parameter, the UE 1g-01 may measure the serving cell through the MR 1g-02 on a longer cycle by multiplying the serving cell measurement cycle through the MR 1g-02 in the foregoing embodiment (FIG. 1E) by K3.
Parameters for not deriving a serving cell measurement result through the MR 1g-02 of the UE 1g-01 or deriving a serving cell measurement result on a longer cycle than in the foregoing embodiment (FIG. 1E) when a serving cell measurement result derived by the UE 1g-01 through the MR 1g-02 satisfies condition 1 and/or condition 2 described above
SservingP and/or SservingQ and/or Tserving

In operation 1g-20, the UE 1g-01 may perform a cell selection procedure, based on the essential system information received in operation 1g-15, which may follow the foregoing embodiment. For reference, the UE 1g-01 may perform the cell selection procedure through the MR 1g-02.

In operation 1g-25, the UE 1g-01 may obtain system information (e.g., SIB2, SIB3, SIB4, SIB5, and a new SIB) including cell reselection information from the serving cell 1g-05 to perform a cell reselection evaluation process, which may follow at least one of the foregoing embodiments. In addition, the system information may broadcast at least one of the following.
Indicator indicating that a serving cell measurement result does not need to be derived through the MR 1g-02, indicator indicating whether a serving cell measurement result may be derived on a longer cycle than in the foregoing embodiment (FIG. 1E), or parameter (e.g., K3) for indicating a longer cycle when a serving cell measurement result derived through the LR 1g-03 of the UE 1g-01 replaces the serving cell measurement result of the MR 1g-02 of the UE 1g-01 (offloading of serving cell measurement from MR to LR) according to the foregoing embodiment (FIG. 1F)
In a case of the parameter, the UE 1g-01 may measure the serving cell through the MR 1g-02 on a longer cycle by multiplying the serving cell measurement cycle through the MR 1g-02 in the foregoing embodiment (FIG. 1E) by K3.
Parameters for not deriving a serving cell measurement result through the MR 1g-02 of the UE 1g-01 or deriving a serving cell measurement result on a longer cycle than in the foregoing embodiment (FIG. 1E) when a serving cell measurement result derived by the UE 1g-01 through the MR 1g-02 satisfies condition 1 and/or condition 2 described above
SservingP and/or SservingQ and/or Tserving

The UE 1g-01 may perform the cell reselection evaluation process. The cell reselection evaluation process may refer to a series of processes for reselecting a cell by performing reselection priorities handling, performing frequency measurement by applying measurement rules for cell reselection, and evaluating cell reselection criteria.

In operation 1g-30, the UE 1g-01 may determine a cell reselection priority according to the foregoing embodiment.

In operation 1g-35, the UE 1g-01 may perform frequency measurement for cell reselection, which may follow at least one of the foregoing embodiments. In addition, the UE 1g-01 according to the disclosure may not derive a serving cell measurement result through the MR 1g-02 of the UE 1g-01, or may derive a serving cell measurement result on a longer cycle than in the foregoing embodiment (FIG. 1E) when at least one of the following conditions is satisfied.
When the indicator indicating that the serving cell measurement result does not need to be derived through the MR 1g-02, the indicator indicating whether the serving cell measurement result may be derived on the longer cycle than in the foregoing embodiment (FIG. 1E), or the parameter (e.g., K3) for indicating the longer cycle is provided in operation 1g-08 and/or operation 1g-15 and/or operation 1g-25 when a serving cell measurement result derived through the LR 1g-03 of the UE 1g-01 replaces a serving cell measurement result of the MR 1g-02 of the UE 1g-01 (offloading of serving cell measurement from MR to LR) according to the foregoing embodiment (FIG. 1F)
When a serving cell measurement result derived by the UE 1g-01 through the MR 1g-02 satisfies condition 1 and/or condition 2 described above

In operation 1g-40, The UE 1g-01 may determine to reselect a cell satisfying the cell reselection criteria, based on the value of the measurement performed in operation 1g-35, which may follow the foregoing embodiment.

In operation 1g-45, the UE 1g-01 may receive system information (e.g., an MIB or SIB1) broadcasted by a candidate target cell before finally reselecting the candidate target cell, and may determine, based on the received system information, whether both the cell selection reception signal level (Srxlev) and the cell selection signal quality (Squal) of the candidate target cell are greater than 0 (i.e., satisfy a cell selection criterion (Srxlev>0 and Squal>0)). When the cell selection criterion is satisfied and the candidate target cell is suitable, the UE 1g-01 may reselect the candidate target cell.

FIG. 1H is a block diagram illustrating an internal structure of a UE according to an embodiment of the disclosure.

Referring to FIG. 1H, the UE may include a radio frequency (RF) processor 1h-10, a baseband processor 1h-20, a storage unit 1h-30, and a controller 1h-40.

The RF processor 1h-10 may perform functions for transmitting/receiving signals through a radio channel, such as signal band conversion and amplification. For example, the RF processor 1h-10 may up-convert a baseband signal provided from the baseband processor 1h-20 to an RF band signal, may transmit the same through an antenna, and may down-convert an RF band signal received through the antenna to a baseband signal. For example, the RF processor 1h-10 may include a transmission filter, a reception filter, an amplifier, a mixer, an oscillator, a digital-to-analog converter (DAC), an analog-to-digital converter (ADC), and the like. Although only one antenna is illustrated in FIG. 1H, the UE may include multiple antennas. In addition, the RF processor 1h-10 may include multiple RF chains. Furthermore, the RF processor 1h-10 may perform beamforming. For the beamforming, the RF processor 1h-10 may adjust the phase and magnitude of signals transmitted/received through multiple antennas or antenna elements, respectively. In addition, the RF processor may perform MIMO, and may receive multiple layers when performing a MIMO operation.

The baseband processor 1h-20 may perform functions of conversion between baseband signals and bitstrings according to the physical layer specifications of the system. For example, during data transmission, the baseband processor 1h-20 may encode and modulate a transmitted bitstring to generate complex symbols. In addition, during data reception, the baseband processor 1h-20 may demodulate and decode a baseband signal provided from the RF processor 1h-10 to restore a received bitstring. For example, when following the orthogonal frequency division multiplexing (OFDM) scheme, during data transmission, the baseband processor 1h-20 may encode and modulate a transmitted bitstring to generate complex symbols, may map the complex symbols to subcarriers, and may configure OFDM symbols through inverse fast Fourier transform (IFFT) operation and cyclic prefix (CP) insertion. In addition, during data reception, the baseband processor 1h-20 may split a baseband signal provided from the RF processor 1h-10 at the OFDM symbol level, may restore signals mapped to subcarriers through a fast Fourier transform (FFT) operation, and may restore a received bitstring through demodulation and decoding.

The baseband processor 1h-20 and the RF processor 1h-10 may transmit and receive signals as described above. Therefore, the baseband processor 1h-20 and the RF processor 1h-10 may be referred to as a transmitter, a receiver, a transceiver, or a communication unit. Furthermore, at least one of the baseband processor 1h-20 and the RF processor 1h-10 may include multiple communication modules to support multiple different radio access technologies. In addition, at least one of the baseband processor 1h-20 and the RF processor 1h-10 may include different communication modules to process signals in different frequency bands. For example, the different radio access technologies may include wireless LANs (for example, IEEE 802.11), cellular networks (for example, LTE), and the like. In addition, the different frequency bands may include super high frequency (SHF) (e.g., 2 NRHz) bands and millimeter wave (mmWave) (e.g., 60 GHz) bands.

The storage unit 1h-30 may store basic programs, application programs, and data, such as configuration information, for operation of the main base station. More particularly, the storage unit 1h-30 may store information regarding a second access node configured to perform wireless communication by using a second radio access technology. In addition, the storage unit 1h-30 may provide the stored data at the request of the controller 1h-40. The controller 1h-40 may include a multi-connection processor 1h-42.

The controller 1h-40 controls the overall operation of the UE. For example, the controller 1h-40 may transmit/receive signals through the baseband processor 1h-20 and the RF processor 1h-10. In addition, the controller 1h-40 records data in the storage unit 1h-30 and reads the data from the storage unit 1h-30. To this end, the controller 1h-40 may include at least one processor. For example, the controller 1h-40 may include a communication processor (CP) configured to perform control for communication, and an application processor (AP) configured to control upper layers, such as application programs.

FIG. 1I is a block diagram illustrating a structure of a base station according to an embodiment of the disclosure.

Referring to FIG. 1I, the base station may include an RF processor 1i-10, a baseband processor 1i-20, a backhaul communication unit 1i-30, a storage unit 1i-40, and a controller 1i-50.

The RF processor 1i-10 may perform functions for transmitting/receiving signals through a radio channel, such as signal band conversion and amplification. For example, the RF processor 1i-10 may up-convert a baseband signal provided from the baseband processor 1i-20 to an RF band signal, may transmit the same through an antenna, and may down-convert an RF band signal received through the antenna to a baseband signal. For example, the RF processor 1i-10 may include a transmission filter, a reception filter, an amplifier, a mixer, an oscillator, a DAC, and an ADC. Although only one antenna is illustrated in the drawing, the first access node may include multiple antennas. In addition, the RF processor 1i-10 may include multiple RF chains. Furthermore, the RF processor 1i-10 may perform beamforming. For the beamforming, the RF processor 11i10 may adjust the phase and magnitude of signals transmitted/received through multiple antennas or antenna elements, respectively. The RF processor may transmit one or more layers to perform a downward MIMO operation.

The baseband processor 1i-20 may perform functions of conversion between baseband signals and bitstrings according to the physical layer specifications of a first radio access technology. For example, during data transmission, the baseband processor 1i-20 may encode and modulate a transmitted bitstring to generate complex symbols. In addition, during data reception, the baseband processor 1i-20 may demodulate and decode a baseband signal provided from the RF processor 1i-10 to restore a received bitstring. For example, when following the OFDM scheme, during data transmission, the baseband processor 1i-20 may encode and modulate a transmitted bitstring to generate complex symbols, may map the complex symbols to subcarriers, and may configure OFDM symbols through IFFT operation and CP insertion. In addition, during data reception, the baseband processor 1i-20 may split a baseband signal provided from the RF processor 1i-10 at the OFDM symbol level, may restore signals mapped to subcarriers through FFT operation, and may restore a received bitstring through demodulation and decoding. The baseband processor 1i-20 and the RF processor 1i-10 may transmit and receive signals as described above. Therefore, the baseband processor 1i-20 and the RF processor 1i-10 may be referred to as a transmitter, a receiver, a transceiver, or a communication unit.

The backhaul communication unit 1i-30 provides an interface for communicating with other nodes in the network. For example, the backhaul communication unit 1i-30 converts bitstrings transmitted from the main base station to other nodes, for example, an auxiliary base station, a core network, or the like, into physical signals, and converts physical signals received from the other nodes into bitstrings.

The storage unit 1i-40 may store basic programs, application programs, and data, such as configuration information, for operation of the base station. More particularly, the storage unit 1i-40 may store information regarding a bearer allocated to a connected UE, a measurement result reported from the connected UE, and the like. In addition, the storage unit 1i-40 may store information serving as a reference to determine whether to provide multi-connection to a UE or to suspend the same. In addition, the storage unit 1i-40 may provide the stored data at the request of the controller 1i-50.

The controller 1i-50 controls the overall operation of the base station. For example, the controller 1i-50 transmits/receives signals through the baseband processor 1i-20 and the RF processor 1i-10 or through the backhaul communication unit 1i-30. In addition, the controller 1i-50 records data in the storage unit 1i-40 and reads the data from the storage unit 1i-40. To this end, the controller 1i-50 may include at least one processor. The controller 1i-50 may include a multi-connection processor 1i-52.

In the disclosure, the controller may be defined as a circuit or an application-specific integrated circuit or at least one processor. The processor may include a communication processor (CP) which performs control for communication and an application processor (AP) which controls upper layers, such as application programs. The controller may control the overall operation of the UE according to the embodiments proposed in the disclosure. For example, the controller may control signal flows between the respective blocks to perform operations according to the above-described flowcharts.

Methods disclosed in the claims or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including random access memory and flash memory, read only memory (ROM), electrically erasable programmable read only memory (EEPROM), magnetic disc storage device, compact disc-ROM (CD-ROM), digital versatile discs (DVDs), or other type optical storage devices, or a magnetic cassette. Alternatively, any combination of some or all of them may form memory in which the program is stored. In addition, a plurality of such memories may be included in the electronic device.

Furthermore, the programs may be stored in an attachable storage device which can access the electronic device through communication networks, such as the Internet, Intranet, local area network (LAN), wide LAN (WLAN), and storage area network (SAN) or a combination thereof. Such a storage device may access the electronic device via an external port. In addition, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a terminal in a wireless communication system, the method comprising:
receiving, from a base station, configuration information on a cell reselection;
preforming a measurement based on the configuration information using a main radio (MR) of the terminal; and
in case that a result of the measurement is higher than a predetermined threshold, determining to relax the measurement using the MR of the terminal.

2. The method of claim 1, further comprising:
performing a measurement based on the configuration information using a low power wakeup signal receiver (LR) of the terminal; and
in case that a result of the measurement using the LR of the terminal satisfies predetermined condition, determining that the result of the measurement using the LR of the terminal is offloaded to the result of the measurement using the MR of the terminal.

3. The method of claim 1, further comprising:
transmitting, to the base station, capability information on the terminal including at least one of information indicating whether the terminal supports relaxed measurement using the MR or information indicating whether the terminal supports a low power wakeup signal receiver (LR) of the terminal.

4. The method of claim 1, wherein the configuration information is received via system information.

5. The method of claim 1, wherein the terminal is in an idle state or an inactive state.

6. The method of claim 2, wherein the predetermined condition includes at least one of whether the result of the measurement using the LR is higher than a first threshold, whether the result of the measurement using the LR is lower than a second threshold, or whether the result of the measurement using the LR is higher than the first threshold and lower than the second threshold.

7. The method of claim 1, wherein the result of the measurement includes at least one of a cell selection quality value or a cell selection receiving level value.

8. A terminal in a wireless communication system, the terminal comprising:
a transceiver; and
a controller coupled with the transceiver and configured to:
receive, from a base station, configuration information on a cell reselection,
preform a measurement based on the configuration information using a main radio (MR) of the terminal, and
in case that a result of the measurement is higher than a predetermined threshold, determine to relax the measurement using the MR of the terminal.

9. The terminal of claim 8, wherein the controller is further configured to:
perform a measurement based on the configuration information using a low power wakeup signal receiver (LR) of the terminal; and
in case that a result of the measurement using the LR of the terminal satisfies predetermined condition, determine that the result of the measurement using the LR of the terminal is offloaded to the result of the measurement using the MR of the terminal.

10. The terminal of claim 8, wherein the controller is further configured to:
transmit, to the base station, capability information on the terminal including at least one of information indicating whether the terminal supports relaxed measurement using the MR or information indicating whether the terminal supports a low power wakeup signal receiver (LR) of the terminal.

11. The terminal of claim 8, wherein the configuration information is received via system information.

12. The terminal of claim 8, wherein the terminal is in an idle state or an inactive state.

13. The terminal of claim 9, wherein the predetermined condition includes at least one of whether the result of the measurement using the LR is higher than a first threshold, whether the result of the measurement using the LR is lower than a second threshold, or whether the result of the measurement using the LR is higher than the first threshold and lower than the second threshold.

14. The terminal of claim 8, wherein the result of the measurement includes at least one of a cell selection quality value or a cell selection receiving level value.
